(19) United States
(12) Patent Application Publication
(10) Pub. No.: US 2021/0279649 A1
(43) Pub. Date: Sep. 9, 2021

(54) SYSTEM, SERVER, AND STORAGE DEVICE

(71) Applicant: KYOCERA Corporation, Kyoto (JP)

(72) Inventors: Takaomi ARAKI, Yokohama-shi (JP); Toshikazu KAWAUCHI, Yokohama-shi (JP); Gen MATSUI, Tokyo (JP)

(73) Assignee: KYOCERA Corporation, Kyoto (JP)

(21) Appl. No.: 17/105,842

(22) Filed: Nov. 27, 2020

Related U.S. Application Data
(60) Provisional application No. 62/985,051, filed on Mar. 4, 2020.

(51) Int. Cl. G06Q 10/02; G06Q 10/08; G06Q 50/30

(52) U.S. Cl. CPC G06Q 10/02; G06Q 50/30; G06Q 10/0832; G06Q 10/0833

(57) ABSTRACT

A system includes a server, a company terminal for use by a delivery company, a recipient terminal for use by a recipient of a package, and a storage device including a container to store the package. When the storage device is selected, by the delivery company on the company terminal, to reserve the container, the delivery terminal transmits a request to reserve the container to the server. When the storage device receives the request from the server, the storage device reserves the container and transmits a notification indicating that the container is reserved to the server. When the server receives the notification, the server transmits information indicating that the container is reserved to the recipient terminal. When the recipient terminal receives the information indicating that the container is reserved from the server, the recipient terminal displays the information indicating that the container is reserved on the recipient terminal.

### TECHNICAL FIELD

The present disclosure relates to a system, a server, and a storage device.

### BACKGROUND

In recent years, as e-commerce markets have grown, the number of deliveries performed by package delivery services to deliver products purchased by mail-order, for example, has rapidly increased. At the same time, the number of nuclear families or one-person households has increased, particularly in urban areas. It is therefore often the case that nobody is home to receive a package delivered by a home delivery company. The package then needs to be redelivered.

To address this issue, a package storage box is sometimes installed at the entrance of housing complexes, such as apartments or condominiums. A package for a recipient that is not at home at the time of delivery can be stored in the package storage box. Ways of using such package storage boxes efficiently have been proposed.

For example, patent literature (PTL) 1 discloses a delivery box capable of storing products delivered to a recipient. An electronic lock is attached to the door of the delivery box. When a product is stored in the delivery box, the key (password) for releasing the electronic lock is transmitted to a user terminal and to the delivery box.

### CITATION LIST

### Patent Literature

PTL 1: WO2018/207269

### SUMMARY

A system according to an embodiment includes:

a server;

a terminal to be used by a delivery company;

a terminal to be used by a recipient of a package; and

a storage device including a container configured to store the package.

When the storage device is selected, by the delivery company on the terminal to be used by the delivery company, to reserve the container, the terminal to be used by the delivery company is configured to transmit a request for reservation of the container to the server.

When the storage device receives the request from the server, the storage device is configured to reserve the container and transmit a notification indicating that the container is reserved to the server.

When the server receives the notification, the server is configured to transmit information indicating that the container is reserved to the terminal to be used by the recipient of the package.

When the terminal to be used by the recipient of the package receives the information indicating that the container is reserved from the server, the terminal to be used by the recipient of the package is configured to display the information indicating that the container is reserved on the terminal to be used by the recipient of the package.

A storage device according to an embodiment includes:

a container;

a controller; and

a communication interface configured to communicate with the server.

When the controller receives a request for reservation of the container from the server, the controller is configured to reserve the container and transmit a notification indicating that the container is reserved to the server.

A server according to an embodiment includes:

a controller; and

a communication interface configured to communicate with a terminal to be used by a recipient of a package and a storage device including a container configured to store the package;

wherein when the controller receives a notification, via the communication interface, indicating that the container is reserved, the controller is configured to transmit information, via the communication interface, indicating that the container is reserved to the terminal to be used by the recipient of the package.

### BRIEF DESCRIPTION OF THE DRAWINGS

In the accompanying drawings:

FIG. 1 illustrates the configuration of a system according to an embodiment;

FIG. 2 is a functional block diagram illustrating the schematic configuration of a management server according to an embodiment;

FIG. 3 is a functional block diagram illustrating the schematic configuration of a delivery box according to an embodiment;

FIG. 4 is a functional block diagram illustrating the schematic configuration of a company server according to an embodiment;

FIG. 5 is a functional block diagram illustrating the schematic configuration of a company terminal according to an embodiment;

FIG. 6 is a functional block diagram illustrating the schematic configuration of a recipient terminal according to an embodiment;

FIG. 7 illustrates operations of the system according to an embodiment;

FIG. 8 illustrates an example of the content displayed on a display of the company terminal according to an embodiment;

FIG. 9 illustrates an example of the content displayed on the display of the company terminal according to an embodiment;

FIG. 10 illustrates an example of the content displayed on a display of the recipient terminal according to an embodiment;

FIG. 11 illustrates operations of the system according to an embodiment;

FIG. 12 illustrates operations of the system according to an embodiment;

FIG. 13 illustrates an example of the content displayed on the display of the company terminal according to an embodiment;

FIG. 14 illustrates operations of the system according to an embodiment;

FIG. 15 illustrates an example of the content displayed on the display of the delivery box according to an embodiment; and

FIG. 16 illustrates operations of the system according to an embodiment.

### DETAILED DESCRIPTION

In the present disclosure, the “storage device” may be a device for storing packages, such as products transported by a package delivery service or the like. For example, the “storage device” may be a package storage box, as described above. Specifically, the “storage device” may be a delivery box or a delivery locker. The “storage device” of the present disclosure may be a device or apparatus driven by electric power. “Storage” may refer to placing an item, such as a delivered product, in a certain location. The “user” of the storage device in the present disclosure may be the person who uses the storage device according to an embodiment. The “user” of the storage device may include not only the recipient of a package delivered by a package delivery service and people related to the recipient, such as family members, but also personnel of the delivery company that delivers the package through a package delivery service, for example.

A representative example of the “package delivery service” in the present disclosure is a service that delivers lightweight, small packages to general households. The “package delivery service” in the present disclosure, however, is not limited to a service for general households or the like. Furthermore, the packages delivered by the “package delivery service” in the present disclosure are not limited to being lightweight nor to being small. The “package” in the present disclosure may be a transported package such as a product delivered by delivery company, such as a package delivery service.

In the context of a service to deliver packages to recipients, it would be advantageous for both the delivery company and for recipients of packages if package delivery could be streamlined. It would therefore be helpful to provide a system, a server, and a storage device capable of streamlining package delivery in the context of a service to deliver packages to recipients. A system, a server, and a storage device according to embodiments of the present disclosure are capable of streamlining package delivery in the context of a service to deliver packages to recipients. A system including a management server according to an embodiment is now described with reference to the drawings.

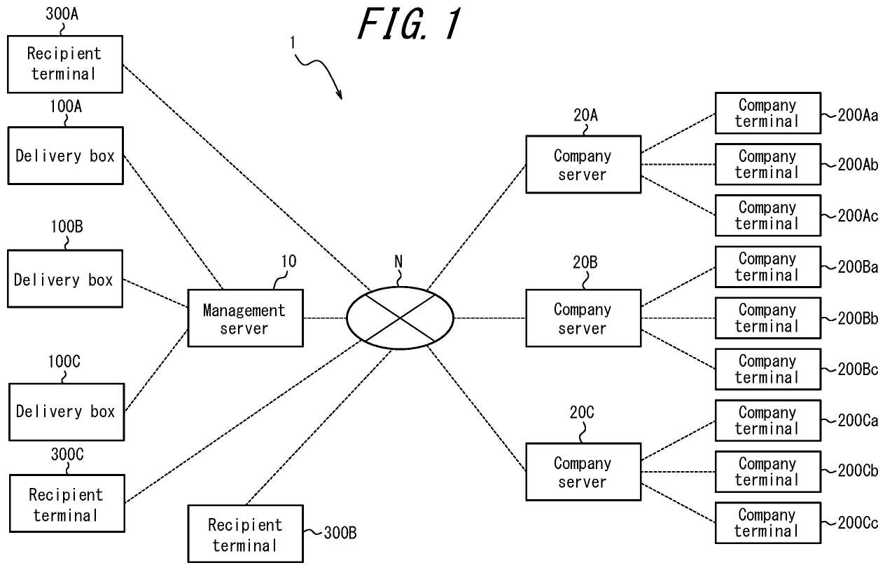

FIG. 1 illustrates the configuration of a system according to an embodiment. As illustrated in FIG. 1, a system 1 according to an embodiment includes a management server 10 and a company server 20. The management server 10 and the company server 20 may be connected over a wired or wireless network N, as illustrated in FIG. 1. The system 1 according to an embodiment may include a delivery box 100, a company terminal 200, and a recipient terminal 300, as illustrated in FIG. 1. Elements connectable in a wired or wireless manner are indicated by dashed lines in FIG. 1.

In the present disclosure, the “server” may be a computer that provides a service. In other words, the “server” may be a computer and/or software that has the function of providing information and/or processing results in response to a request from a client, like the server in a client/server model.

The management server 10 according to an embodiment is a server that manages and/or controls the delivery box 100. The management server 10 according to an embodiment may be a server operated by a delivery company that delivers packages to a storage device, such as the delivery box 100 (for example, when the recipient is not home). However, the management server 10 according to an embodiment is not necessarily operated by a delivery company. The management server 10 according to an embodiment may be a server operated by a company that provides a service such as collective management of delivery boxes of a plurality of delivery companies (including other companies in the same industry). The management server 10 may, for example, be a cloud server that provides a cloud service.

The management server 10 manages and/or controls at least one delivery box 100. The management server 10 in FIG. 1 is connected to a delivery box 100A, a delivery box 100B, and a delivery box 100C. The management server 10 may be connected in a wired or wireless manner to any number, one or greater, of delivery boxes 100. In the present disclosure, a plurality of delivery boxes such as the delivery box 100A and the delivery box 100B may simply be referred to as the “delivery box 100” when no distinction therebetween need be made.

The delivery box 100 according to an embodiment may be a storage device usable as a package storage box, such as the delivery box or delivery locker described above. The delivery box 100 according to an embodiment may be an apparatus for storing a package, such as a product delivered by a home delivery company or other such delivery company, until the recipient receives the package. In other words, a home delivery company or other such delivery company can store a delivered package, such as a product, in the delivery box 100 when the recipient of the package is not home. The recipient of the delivered package, such as a product, can receive the package that was delivered while the recipient was not home or available from the delivery box 100. As described above, each of the one or more delivery boxes 100 is managed and/or controlled by the management server 10. The delivery box 100 is illustrated in FIG. 1 as being connectable to the management server 10. The delivery box 100 may instead be connectable to the management server 10 over the network N, for example.

The management server 10 may be connected over the network N to at least one company server 20 in a wired or wireless manner. In FIG. 1, the management server 10 is connected to a company server 20A, a company server 20B, and a company server 20C. The management server 10 may be connected in a wired or wireless manner to any number, one or greater, of company servers 20. In the present disclosure, a plurality of company servers 20 such as the company server 20A and the company server 20B may simply be referred to as the “company server 20” when no distinction therebetween need be made.

The company server 20 according to an embodiment may be a server used by staff members of the company providing the delivery service or the like, typically a package delivery service. For example, the company server 20A may be a server used by the staff members of company A, which is a company providing delivery services and the like. The company server 20B may be a server used by the staff members of company B, which is another company providing delivery services and the like. The company server 20C may be a server used by the staff members of company C, which is another a company providing delivery services and the like.

The company server 20 transmits various information related to delivery of a package, for example, in response to a request. In response to a request from a staff member delivering packages, for example, the company server 20 may generate and provide a delivery plan regarding the packages for which the staff member is responsible.

In FIG. 1, the company server 20A is connected to a company terminal 200Aa, a company terminal 200Ab, and a company terminal 200Ac. The company server 20B is connected to a company terminal 200Ba, a company terminal 200Bb, and a company terminal 200Bc. The company server 20C is connected to a company terminal 200Ca, a company terminal 200Cb, and a company terminal 200Cc. In this way, the company server 20A, company server 20B, and company server 20C may each be connected in a wired or wireless manner to at least one company terminal 200.

In the present disclosure, a plurality of company terminals such as the company terminal 200Aa and the company terminal 200Ab may simply be referred to as the “company terminal 200A” when no distinction therebetween need be made. Similarly, in the present disclosure, a plurality of company terminals such as the company terminal 200Ba and the company terminal 200Bb may simply be referred to as the “company terminal 200B” when no distinction therebetween need be made. Similarly, in the present disclosure, a plurality of company terminals such as the company terminal 200Ca and the company terminal 200Cb may simply be referred to as the “company terminal 200C” when no distinction therebetween need be made. In the present disclosure, a plurality of company terminals such as the company terminal 200A and the company terminal 200B may simply be referred to as the “company terminal 200” when no distinction therebetween need be made.

The company terminal 200 may be a terminal used by staff members of the company providing the delivery service or the like, typically a package delivery service. For example, the company terminal 200A may be used by the staff members of company A, which is a company providing delivery services and the like. The company terminal 200B may be used by the staff members of company B, which is a company providing delivery services and the like. The company terminal 200C may be used by the staff members of company C, which is a company providing delivery services and the like.

The company terminal 200 according to an embodiment may be a terminal used by a staff member, among the staff members of a business that provides delivery services such as a package delivery service, who collects a package from a client and delivers the package to a recipient. For example, the company terminal 200 may be a terminal used by the staff member of a business that provides delivery services, such as a package delivery service, to input information related to delivery when a delivery request is received. The company terminal 200 may, for example, be a code reader that has the function of reading a two-dimensional code, such as a barcode or a QR code® (QR code is a registered trademark in Japan, other countries, or both). The company terminal 200 may also be a terminal such as a car navigation system used in a delivery vehicle ridden by a staff member of a business that provides delivery services, such as a package delivery service. The company terminal 200 may also be any of various types of terminals capable of transmitting and/or receiving information provided to staff members of a business that provides delivery services, such as a package delivery service. The company terminal 200 is illustrated in FIG. 1 as being connectable to the company server 20. The company terminal 200 may instead be connectable to the company server 20 over the network N, for example.

The example of the system 1 illustrated in FIG. 1 includes a recipient terminal 300A, a recipient terminal 300B, and a recipient terminal 300C. In the present disclosure, a plurality of recipient terminals such as the recipient terminal 300A and the recipient terminal 300B may simply be referred to as the “recipient terminals 300” when no distinction therebetween need be made. In an embodiment, the recipient terminal 300 may be a terminal used by the recipient of a delivered package.

The recipient terminal 300A may be used by a recipient living in a residence where the delivery box 100A is installed, as illustrated in FIG. 1. The recipient terminal 300C may be used by a recipient living in a residence where the delivery box 100C is installed, as illustrated in FIG. 1. On the other hand, the recipient terminal 300B may be used by a recipient living in a residence where no delivery box is installed, as illustrated in FIG. 1.

In FIG. 1, the recipient terminal 300 is connected to the management server 10 over the network N. The recipient terminal 300 may, however, be connected to the management server 10 without passing through the network N. The recipient terminal 300 may, for example, be connected in a wired or wireless manner to at least one of the delivery box 100, the company server 20, and the company terminal 200.

The recipient terminal 300 according to an embodiment may be a dedicated terminal adapted to the system 1 or may be a smartphone, mobile phone, tablet, or the like. In the case of using a smartphone, mobile phone, tablet, or the like as the recipient terminal 300, an application used in the system 1 may be installed on the recipient terminal 300, for example. The recipient terminal 300 may be implemented in an Internet browser. In this case, the recipient terminal 300 is not limited to being a smartphone, mobile phone, or tablet and may also be a notebook PC, desktop PC, or the like.

The network N illustrated in FIG. 1 is configured to be wired, wireless, or any combination of wired and wireless. The network N may be any network, such as the Internet or an intranet, that enables the management server 10 to communicate with another electronic device, such as at least one of the company server 20, the company terminal 200, and the recipient terminal 300.

Next, the configuration of each of the management server 10, the delivery box 100, the company server 20, the company terminal 200, and the recipient terminal 300 illustrated in FIG. 1 is described in more detail.

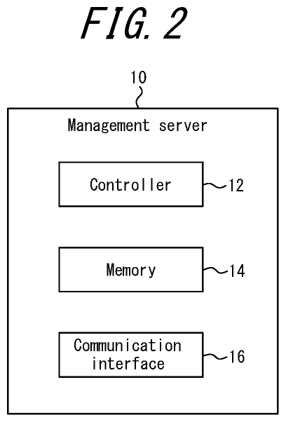

FIG. 2 is a functional block diagram illustrating the schematic configuration of the management server 10 according to an embodiment.

As illustrated in FIG. 2, the management server 10 according to an embodiment includes a controller 12, a memory 14, and a communication interface 16. A portion of the functional components illustrated in FIG. 2 may be omitted from the management server 10 according to an embodiment, and functional components other than those illustrated in FIG. 2 may be included.

The controller 12 executes various functions for controlling and/or managing the management server 10. The controller 12 may include at least one processor, such as a central processing unit (CPU), to provide control and processing capability for executing various functions. The controller 12 may be implemented collectively by one processor, implemented by several processors, or implemented by individual processors. The processor may be implemented as a single integrated circuit (IC). The processor may be implemented as a plurality of integrated circuits and discrete circuits communicably connected to each other. The processor may be implemented based on various other known techniques. In an embodiment, the controller 12 may be configured by a CPU and a program executed by the CPU. Programs executed by the controller 12, the result of processing executed by the controller 12, and the like may be stored in the memory 14. Operations by the controller 12 of the management server 10 according to an embodiment are further described below.

In an embodiment, the controller 12 may include a function to measure time, such as a timer function. The controller 12 may include a function to start measuring time based on a predetermined trigger. The controller 12 may include a function to measure a predetermined length of time. Furthermore, the controller 12 may include a function to notify other functional components, for example, of the elapse of a predetermined length of time.

The memory 14 stores various information acquired from the controller 12, the communication interface 16, and the like. In an embodiment, the memory 14 may store information inputted by a user or the like. The memory 14 also stores programs, executed by the controller 12, and the like. The memory 14 additionally stores various data, such as calculation results from the controller 12. Furthermore, the memory 14 may include a working memory or the like at the time of operation of the controller 12. The memory 14 can, for example, be configured by a semiconductor memory, a magnetic disc, or the like. The memory 14 is not limited to these examples, however, and can be any memory device. For example, the memory 14 may be a storage medium such as a memory card inserted in the management server 10 according to an embodiment. The memory 14 may be an internal memory of the CPU used as the controller 12.

The communication interface 16 can implement various functions, starting with wireless communication. The communication interface 16 may implement communication with various communication methods, such as Long Term Evolution (LTE), 4G, or 5G. The communication interface 16 may, for example, include a modem with a standardized communication method in the International Telecommunication Union Telecommunication Standardization Sector (ITU-T). The communication interface 16 may, for example, implement wireless communication by various methods such as WiFi or Bluetooth® (Bluetooth is a registered trademark in Japan, other countries, or both). The communication interface 16 may communicate wirelessly over an antenna, for example, to communicate with a communication interface of an external device such as an external server or a cloud server. In an embodiment, the communication interface 16 may receive various information from an external database, such as an external server or a cloud server. The information received by the communication interface 16 may be provided to the controller 12 and/or the memory 14, for example. The information transmitted by the communication interface 16 may be provided to the controller 12 and/or the memory 14, for example.

Various information transmitted and received by the communication interface 16 may be stored in the memory 14, for example. The communication interface 16 may, for example, be configured to include an antenna for transmitting and receiving radio waves, an appropriate RF unit, and the like. The communication interface 16 can be configured using known techniques for wireless communication. The communication interface 16 may be an interface for wired communication between the management server 10 and other electronic devices.

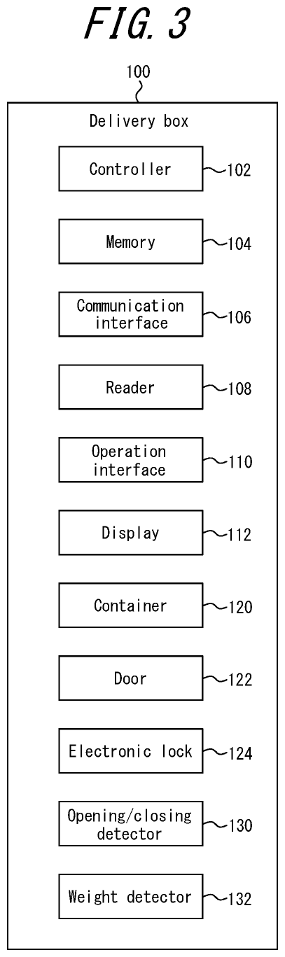

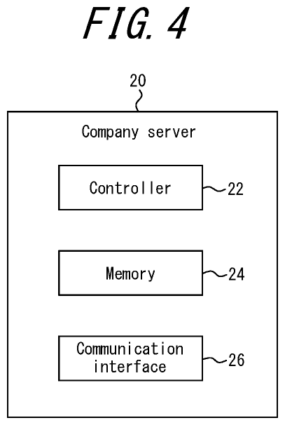

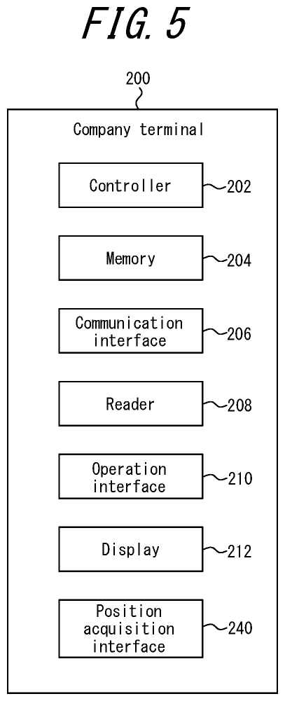

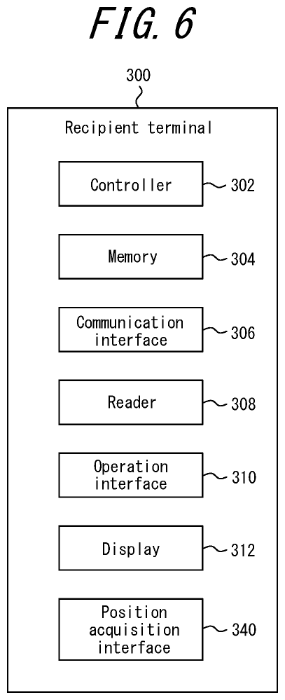

In an embodiment, the communication interface 16 of the management server 10 illustrated in FIG. 2 may communicate in a wired or wireless manner with a communication interface 106 of the delivery box 100 (FIG. 3). The communication interface 16 may communicate in a wired or wireless manner with a communication interface 26 of the company server 20 (FIG. 4). The communication interface 16 may communicate in a wired or wireless manner with a communication interface 206 of the company terminal 200 (FIG. 5). The communication interface 16 may communicate in a wired or wireless manner with a communication interface 306 of the recipient terminal 300 (FIG. 6). The communication interface 16 may communicate in a wired or wireless manner with at least one of the communication interface 26 of the company server 20 and the communication interface 206 of the company terminal 200. In this way, the communication interface 16 in an embodiment may communicate with a storage device, such as the delivery box 100, and with another electronic device such as at least one of the company server 20, the company terminal 200, and the recipient terminal 300. The communication interface 16 may communicate wirelessly with a communication interface of another electronic device, such as an information processing apparatus functioning as an external server.

The management server 10 according to an embodiment may have a similar hardware configuration to that of a server in a typical client server model. As described above, the management server 10 according to an embodiment may also be a cloud server that provides a cloud service, for example.

FIG. 3 is a functional block diagram illustrating the schematic configuration of the delivery box 100 according to an embodiment.

As illustrated in FIG. 3, the delivery box 100 according to an embodiment includes a controller 102, a memory 104, and a communication interface 106. The delivery box 100 according to an embodiment may also include a reader 108, an operation interface 110, and a display 112. The delivery box 100 according to an embodiment may also include a container 120, a door 122, electronic lock 124, an opening/closing detector 130, and a weight detector 132. A portion of the functional components illustrated in FIG. 3 may be omitted from the delivery box 100 according to an embodiment, and functional components other than those illustrated in FIG. 3 may be included.

The controller 102 executes various functions for controlling and/or managing the delivery box 100. The controller 102 may be configured like the controller 12 illustrated in FIG. 2, for example.

The memory 104 stores various information acquired from the controller 102, the communication interface 106, and the like. The memory 104 also stores programs, executed by the controller 102, and the like. The memory 104 additionally stores various data, such as calculation results from the controller 102. The memory 104 may be configured like the memory 14 illustrated in FIG. 2, for example.

The communication interface 106 may communicate in a wired or wireless manner with the communication interface 16 of the management server 10 illustrated in FIG. 2. In this case, the communication interface 106 may communicate with the communication interface 16 of the management server 10 over the network N. The communication interface 106 may be configured like the communication interface 16 illustrated in FIG. 2, for example.

The reader 108 may be configured by a barcode reader and/or a camera, for example, for reading information identifying the recipient that receives the package stored in the delivery box 100. In this case, the camera may be any of various image capturing devices, such as a CCD image sensor. In an embodiment, the recipient that receives a package stored in the delivery box 100 may, for example, hold an identification image over the reader 108. The identification image may be a one-dimensional barcode, a QR code®, or the like displayed on the display of the recipient terminal, such as a smartphone. In this case, the delivery box 100 may authenticate the identification image, such as a one-dimensional barcode or a QR code®, to authenticate whether or not the recipient is a legitimate recipient of the package stored in the delivery box 100.

When the recipient of the package is authenticated as being legitimate, the delivery box 100 may release the electronic lock 124 of the door 122. When the recipient of the package is not authenticated as being legitimate, the delivery box 100 may be configured not to release the electronic lock 124 of the door 122. In this way, only a legitimate recipient can receive the package stored in the delivery box 100. The identification image read by the reader 108 in an embodiment is not limited to being a one-dimensional code such as a barcode, or a two-dimensional code such as a QR code®, and may be any identification image. The identification information read by the reader 108 in an embodiment is also not limited to being image information and may be any information, such as a passcode composed of a character or character sequence. Furthermore, the reader 108 is not limited to being a functional unit such as a barcode reader and/or a camera and may, for example, be an RFID reader that reads identification information from an RF tag. The information read by the reader 108 may be provided to the controller 102 and/or the memory 104, for example.

The reader 108 may include a function to read an identification code, such as a one-dimensional barcode or a QR code®, attached to the delivered package, for example. In this case, the reader 108 is not limited to reading an identification code, such as a one-dimensional barcode or a QR code®, attached to the delivered package and may also read an identification code, such as a one-dimensional barcode or a QR code®, attached to a voucher or the like related to delivery of the package.

The operation interface 110 detects operation by a user, such as the recipient of the package or a staff member of the delivery company, as input. The operation interface 110 may be configured as an input apparatus, such as a keyboard. The operation interface 110 may be any input device to be operated by the user. Examples include a key (physical key) such as a keyboard, a button (physical button), a switch (mechanical switch), and/or a pointing device such as a mouse or trackball. In an embodiment, the operation interface 110 can be any of various known types of input devices. An operation signal (input signal) detected by the operation interface 110 may be provided to the controller 102 and/or the memory 104, for example.

The operation interface 110 may be an input apparatus such as a touch panel or a touch sensor. In this case, the operation interface 110 may be any of various systems of touch panels, such as a resistive film system, a capacitive system, or an optical system.

The display 112 may be any display device such as a liquid crystal display, an organic electro-luminescence (EL) panel, or an inorganic EL panel. The display 112 may display various information such as characters, images, symbols, or graphics. To encourage the user to operate the delivery box 100, the display 112 may display objects, icons, and the like constituting various types of GUIs, such as a pointer. The various data necessary for display on the display 112 may be provided by the controller 102 or the memory 104, for example. The display 112 may include a backlight or the like as appropriate.

Instead of or in addition to the display 112, the delivery box 100 according to an embodiment may include a speaker or the like that transmits various information, by audio, to the user operating the delivery box 100.

In an embodiment, the display 112 may be configured together with the operation interface 110 as a touchscreen display, for example. The touchscreen display in this case may include a display device, such as a liquid crystal display or an organic EL display, as the display 112. The touchscreen display in this case may include a touch sensor or a touch panel, as the operation interface 110, to detect contact by the user and to detect the position of the contact. In such a configuration, a numeric keypad or other such keys, icons, or the like can be displayed on the display 112 as objects, and the operation interface 110 can detect an operation by the operator (user) to contact the objects.

The container 120 is a space in the delivery box 100 for containing a package delivered to the recipient. In other words, when delivering the package to the address of the recipient, the staff member of the delivery company can store the package in the container 120 of the delivery box 100 if the recipient is not home. The container 120 may, for example, form the housing of the delivery box 100. The delivery box 100 may be configured to include a plurality of containers 120 when installed in the entrance or the like of a housing complex, such as an apartment or condominium.

The door 122 may be attached at the location where the package is stored in and removed from the container 120. The door 122 may be configured so that at least a portion of the container 120 is openable. When the door 122 of the delivery box 100 is configured to open, the recipient of the package can remove the package stored in the delivery box 100. When the door 122 of the delivery box 100 is configured to close, people other than the recipient, for example, are prevented from removing the package stored in the delivery box 100 before the recipient removes the package. When the delivery box 100 includes a plurality of containers 120, a door 122 may be attached to each container 120.

The door 122 may be configured to open and close automatically under the control of the controller 102, for example. The door 122 may also be configured to be opened and closed manually by the user, for example.

The electronic lock 124 can engage/release the lock while the door 122 is closed. The electronic lock 124 may electronically lock the door 122, for example. In an embodiment, the electronic lock 124 may selectively engage and release the lock of at least one of a plurality of doors 122. In this case, the controller 102 may control the engagement and release of the electronic lock 124. When the delivery box 100 includes a plurality of containers 120, the electronic lock 124 may be attached to each door 122 of the containers 120.

At least one of the container 120, the door 122, and the electronic lock 124 illustrated in FIG. 3 may be configured in a similar way to a package storage box, such as a delivery box or a delivery locker.

The opening/closing detector 130 may be a sensor for detecting whether the door 122 is open or closed. For example, the opening/closing detector 130 may be a sensor for detecting contact between the door 122 and the container 120. In this case, the opening/closing detector 130 can detect that the door 122 is closed when contact between the door 122 and the container 120 is established. Conversely, the opening/closing detector 130 can detect that the door 122 is open when contact between the door 122 and the container 120 is not established. The opening/closing detector 130 may be a sensor for detecting whether the electronic lock 124 is engaged or released. In this case, the opening/closing detector 130 may judge whether the electronic lock 124 is engaged or released based on a status signal of the electronic lock 124. A signal based on the result of detection by the opening/closing detector 130 may be provided to the controller 102 and/or the memory 104, for example.

The weight detector 132 may be a sensor for detecting the weight of the package stored in the container 120. The weight detector 132 may be a sensor that detects the weight of the package, stored in the container 120, with high accuracy. The weight detector 132 may be a sensor that detects the weight of the package, stored in the container 120, with coarse accuracy. In an embodiment, it suffices for the weight detector 132 to detect the weight of a package with enough accuracy to judge whether a package is stored in container 120. If the weight detector 132 detects a certain weight inside the container 120, it can be judged that a package is stored inside the container 120. Conversely, if the weight detector 132 does not detect a certain weight (for example, when the weight is nearly zero) inside the container 120, it can be judged that a package is not stored inside the container 120.

The weight detector 132 judges whether a package is stored inside the container 120 based on the detected package weight. In an embodiment, an image capturing device, such as a camera, may be used instead of the weight detector 132 to judge whether a package is stored inside the container 120. A signal based on the result of detection by the weight detector 132 may be provided to the controller 102 and/or the memory 104, for example.

The delivery box 100 may, for example, be configured to include only one of the opening/closing detector 130 and the weight detector 132 or to include neither.

FIG. 4 is a functional block diagram illustrating the schematic configuration of the company server 20 according to an embodiment.

As illustrated in FIG. 4, the company server 20 according to an embodiment includes a controller 22, a memory 24, and a communication interface 26. A portion of the functional components illustrated in FIG. 4 may be omitted from the company server 20 according to an embodiment, and functional components other than those illustrated in FIG. 4 may be included. As described above, the company server 20 may be a server used by staff members of the company providing the delivery service or the like, typically a package delivery service.

The controller 22 executes various functions for controlling and/or managing the company server 20. The controller 22 may be configured in the same way as the controller 12 illustrated in FIG. 2, for example.

The memory 24 stores various information acquired from the controller 22, the communication interface 26, and the like. The memory 24 also stores programs, executed by the controller 22, and the like. The memory 24 additionally stores various data, such as calculation results from the controller 22. The memory 24 may be configured like the memory 14 illustrated in FIG. 2, for example.

The communication interface 26 may communicate in a wired or wireless manner with the communication interface 16 of the management server 10 illustrated in FIG. 2. In this case, the communication interface 26 may communicate with the communication interface 16 of the management server 10 over the network N. The communication interface 26 may communicate in a wired or wireless manner with the communication interface 206 of the company terminal 200 (FIG. 5). In this case, the communication interface 26 may communicate with the communication interface 206 of the company terminal 200 over the network N. Furthermore, the communication interface 26 may communicate in a wired or wireless manner with the communication interface 306 of the recipient terminal 300 (FIG. 6). In this case, the communication interface 26 may communicate with the communication interface 306 of the recipient terminal 300 over the network N. The communication interface 26 may be configured like the communication interface 16 illustrated in FIG. 2, for example.

In this way, the company server 20 according to an embodiment may have a similar hardware configuration to that of a server in a typical client server model. The company server 20 according to an embodiment may be a cloud server that provides a cloud service, for example.

FIG. 5 is a functional block diagram illustrating the schematic configuration of the company terminal 200 according to an embodiment.

As illustrated in FIG. 5, the company terminal 200 according to an embodiment includes a controller 202, a memory 204, and the communication interface 206. The company terminal 200 according to an embodiment may also include a reader 208, an operation interface 210, and a display 212. The company terminal 200 according to an embodiment may also include a position acquisition interface 240. A portion of the functional components illustrated in FIG. 5 may be omitted from the company terminal 200 according to an embodiment, and functional components other than those illustrated in FIG. 5 may be included.

The controller 202 executes various functions for controlling and/or managing the company terminal 200. The controller 202 may be configured in the same way as the controller 12 illustrated in FIG. 2, for example.

The memory 204 stores various information acquired from the controller 202, the communication interface 206, and the like. The memory 204 also stores programs, executed by the controller 202, and the like. The memory 204 additionally stores various data, such as calculation results from the controller 202. The memory 204 may be configured like the memory 14 illustrated in FIG. 2, for example.

The communication interface 206 may communicate in a wired or wireless manner with the communication interface 26 of the company server 20 illustrated in FIG. 3. In this case, the communication interface 206 may communicate with the communication interface 26 of the company server 20 over the network N. The communication interface 206 may also communicate in a wired or wireless manner with the communication interface 16 of the management server 10 illustrated in FIG. 2. In this case, the communication interface 206 may communicate with the communication interface 16 of the management server 10 over the network N. The communication interface 206 may be configured like the communication interface 16 illustrated in FIG. 2, for example.

The reader 208 may be configured by a barcode reader and/or a camera, for example, for reading information identifying a package delivered by a delivery company. In this case, the camera may be any of various image capturing devices, such as a CCD image sensor. In an embodiment, a staff member of the delivery company (such as the driver of a delivery vehicle) or the like may hold an identification mark over the reader 208. The identification mark may be a one-dimensional barcode, a QR code®, or the like displayed on a voucher or the like attached to the package to be delivered. In this case, the company terminal 200 can identify the identification mark, such as a one-dimensional barcode or a QR code®, to refer to information associated with the identification mark. The company terminal 200 can also identify the identification mark, such as a one-dimensional barcode or a QR code®, to associate other information with the identification mark. The other information associated with the identification mark may, for example, be information indicating at least one of the name of the sender who requested delivery of the package, the destination of the package to be delivered and the name of the recipient, the desired date and time for delivery of the package, the contents of the package to be delivered, and the like.

The identification mark read by the reader 208 in an embodiment is not limited to being a one-dimensional code such as a barcode, or a two-dimensional code such as a QR code®, and may be any identifying image. The identification information read by the reader 108 in an embodiment is not limited to being image information and may be any information, such as a passcode composed of a character or character sequence. Furthermore, the reader 208 is not limited to being a functional unit such as a barcode reader and/or a camera and may, for example, be an RFID reader that reads identification information from an RF tag. The information read by the reader 208 may be provided to the controller 202 and/or the memory 204, for example.

As described above, the company terminal 200 in an embodiment may be a terminal such as a car navigation system used in a delivery vehicle ridden by a staff member of a business that provides delivery services, such as a package delivery service. In this case, the company terminal 200 that is a terminal such as a car navigation system need not include the reader 208. The staff member in this case may also carry another company terminal 200. The other company terminal 200 carried by the staff member may include the reader 208.

The operation interface 210 detects operation by a user, such as a staff member of the delivery company, as input. The operation interface 210 may be configured as an input apparatus, such as a keyboard. The operation interface 210 may be any input device to be operated by the user. Examples include a key (physical key) such as a keyboard, a button (physical button), a switch (mechanical switch), and/or a pointing device such as a mouse or trackball. In an embodiment, the operation interface 210 can be any of various known types of input devices. An operation signal (input signal) detected by the operation interface 210 may be provided to the controller 202 and/or the memory 204, for example.

The operation interface 210 may be an input apparatus such as a touch panel or a touch sensor. In this case, the operation interface 210 may be any of various systems of touch panels, such as a resistive film system, a capacitive system, or an optical system.

The display 212 may be any display device such as a liquid crystal display, an organic EL panel, or an inorganic EL panel. The display 212 may display various information such as characters, images, symbols, or graphics. To encourage the user to operate the company terminal 200, the display 212 may display objects, icons, and the like constituting various types of GUIs, such as a pointer. The various data necessary for display on the display 212 may be provided by the controller 202 or the memory 204, for example. The display 212 may include a backlight or the like as appropriate.

Instead of or in addition to the display 212, the company terminal 200 according to an embodiment may include a speaker or the like that transmits various information, by audio, to the user operating the company terminal 200.

In an embodiment, the display 212 may be configured together with the operation interface 210 as a touchscreen display. The touchscreen display in this case may include a display device, such as a liquid crystal display or an organic EL display, as the display 212. The touchscreen display in this case may include a touch sensor or a touch panel, as the operation interface 210, to detect contact by the user and to detect the position of the contact. In such a configuration, a numeric keypad or other such keys, icons, or the like can be displayed on the display 212 as objects, and the operation interface 210 can detect an operation by the user to contact the objects. In an embodiment, the display 212 may display the below-described first information (information indicating the probability that the recipient of the package is home) and the below-described second information (information indicating the availability of a storage device, such as the delivery box 100).

The position acquisition interface 240 acquires information related to the position of the company terminal 200. In an embodiment, the position acquisition interface 240 may acquire information related to the position of the delivery vehicle in which the company terminal 200 is installed. The information related to the position, detected by the position acquisition interface 240, of the company terminal 200 may be provided to the controller 202 and/or the memory 204, for example.

The position acquisition interface 240 may acquire location information based on a technique such as a global navigation satellite system (GNSS). A GNSS may include a satellite positioning system, such as global positioning system (GPS), GLONASS, Galileo, or quasi-zenith satellite system (QZSS). The position acquisition interface 240 may be a position information acquisition device such as a GPS module. The position acquisition interface 240 is not limited to a GPS module or the like and may be configured by any device capable of acquiring information related to location.

The position information acquired by the position acquisition interface 240 may include at least one of latitude information, longitude information, and altitude information. The position information acquired by the position acquisition interface 240 is supplied to the controller 202 and/or the memory 204. Based on the position information supplied by the position acquisition interface 240, the controller 202 can identify the current position and the like of the company terminal 200.

The company terminal 200 need not include a mechanism such as a GPS system that acquires its own position. In this case, the company terminal 200 may, for example, acquire the position of the company terminal 200 through the communication interface 206 from a position acquisition interface, such as a GPS system, included in another electronic device that works together with the company terminal 200, such as a smartphone or mobile phone. The company terminal 200 may also acquire the position of the company terminal 200 from a position acquisition interface, such as a GPS system, included in a delivery vehicle ridden by a staff member of a business that provides delivery services, such as a package delivery service.

In this way, the server (management server 10) according to an embodiment may be connectable in a wired or wireless manner to a storage device (delivery box 100) that stores a package delivered to a recipient and to another electronic device (company server 20, company terminal 200, or recipient terminal 300). The communication interface 206 of the company terminal 200 may communicate directly or indirectly with (the communication interface 106 of) a storage device such as the delivery box 100.

FIG. 6 is a functional block diagram illustrating the schematic configuration of the recipient terminal 300 according to an embodiment. As described above, the recipient terminal 300 may be a terminal used by the recipient of a delivered package. The recipient terminal 300 in FIG. 6 may, for example, be a smartphone on which an application used in the system 1 has been installed. The recipient terminal 300 may also be a dedicated terminal conceived for use in the system 1, for example.

In the example illustrated in FIG. 6, the recipient terminal 300 may have a configuration similar to that of the company terminal 200 illustrated in FIG. 5. The recipient terminal 300 illustrated in FIG. 6 may include a controller 302, a memory 304, the communication interface 306, a reader 308, an operation interface 310, a display 312, and a position acquisition interface 340. These functional components may correspond to the functional components illustrated in FIG. 5, namely the controller 202, the memory 204, the communication interface 206, the reader 208, the operation interface 210, the display 212, and the position acquisition interface 240.

The communication interface 306 may communicate in a wired or wireless manner with the communication interface 16 of the management server 10 illustrated in FIG. 2. In this case, the communication interface 306 may communicate with the communication interface 16 of the management server 10 over the network N. The communication interface 306 may also communicate in a wired or wireless manner with the communication interface 26 of the company server 20 illustrated in FIG. 3. In this case, the communication interface 306 may communicate with the communication interface 26 of the company server 20 over the network N.

Next, operations of the system 1 including the management server 10 according to an embodiment are further described. The system 1 that includes the management server 10 according to an embodiment can be used in various situations when a delivery company or the like provides a service related to delivery.

An overview of the form of use of each element included in the system 1 according to an embodiment is now provided. First, before delivering a package to a recipient, a staff member of a home delivery company or the like can use the company terminal 200 to reserve the delivery box 100 installed at the residence of the recipient or the like. After the delivery box 100 is reserved, the recipient of the package can use the recipient terminal 300 to learn that the delivery box 100 has been reserved for a package to be delivered. The reservation of the delivery box 100 reserved in this way is cancelled after a predetermined time elapses. The staff member of the home delivery company or the like is therefore motivated to deliver the package before the reservation is canceled. Furthermore, this configuration can reduce the frequency with which the delivery box 100 remains reserved for an extended period of time, preventing other packages from being stored.

When the recipient of the package learns that the delivery box 100 was reserved, the recipient can choose whether he or she wishes to have the package stored in the delivery box 100 or to receive the package by hand. When the recipient selects storage of the package, the staff member of the home delivery company or the like can store the package in the reserved delivery box 100 at the time of delivery. On the other hand, when the recipient selects hand delivery of the package, the staff member of the home delivery company or the like can learn from the company terminal 200 and the delivery box 100 that the recipient wishes the package to be delivered by hand. The staff member of the home delivery company or the like can therefore hand deliver the package to the recipient.

It is envisioned that even when the recipient has selected hand delivery of the package, the staff member of the home delivery company or the like might not be able to deliver the package to the recipient by hand at the time of delivery. In such a situation as well, the staff member of the home delivery company or the like can store the package in the reserved delivery box 100. Each element used in the above-described form of use of the system 1 according to an embodiment is further described below.

In the explanation below, the operations mainly performed by the management server 10 may be performed by control of the controller 12 in the management server 10. In other words, operations “performed by the management server 10” may be operations “performed by control of the controller 12”. “Storage/recording” by the management server 10 may be storage/recording by the memory 14 of the management server 10. Furthermore, “transmission/reception” by the management server 10 may be transmission/reception by the communication interface 16 of the management server 10.

Similarly, the operations mainly performed by the delivery box 100 may be performed by control of the controller 102 in the delivery box 100. In other words, operations “performed by the delivery box 100” may be operations “performed by control of the controller 102”. “Storage/recording” by the delivery box 100 may be storage/recording by the memory 104 of the delivery box 100. Furthermore, “transmission/reception” by the delivery box 100 may be transmission/reception by the communication interface 106 of the delivery box 100.

Similarly, the operations mainly performed by the company server 20 may be performed by control of the controller 22 in the company server 20. In other words, operations “performed by the company server 20” may be operations “performed by control of the controller 22”. “Storage/recording” by the company server 20 may be storage/recording by the memory 24 of the company server 20. Furthermore, “transmission/reception” by the company server 20 may be transmission/reception by the communication interface 26 of the company server 20.

Similarly, the operations mainly performed by the company terminal 200 may be performed by control of the controller 202 in the company terminal 200. In other words, operations “performed by the company terminal 200” may be operations “performed by control of the controller 202”. “Storage/recording” by the company terminal 200 may be storage/recording by the memory 204 of the company terminal 200. Furthermore, “transmission/reception” by the company terminal 200 may be transmission/reception by the communication interface 206 of the company terminal 200.

Similarly, the operations mainly performed by the recipient terminal 300 may be performed by control of the controller 302 in the recipient terminal 300. In other words, operations “performed by the recipient terminal 300” may be operations “performed by control of the controller 302”. “Storage/recording” by the recipient terminal 300 may be storage/recording by the memory 304 of the recipient terminal 300. Furthermore, “transmission/reception” by the recipient terminal 300 may be transmission/reception by the communication interface 306 of the recipient terminal 300.

### Reservation Application of Delivery Box 100 on Company Terminal 200

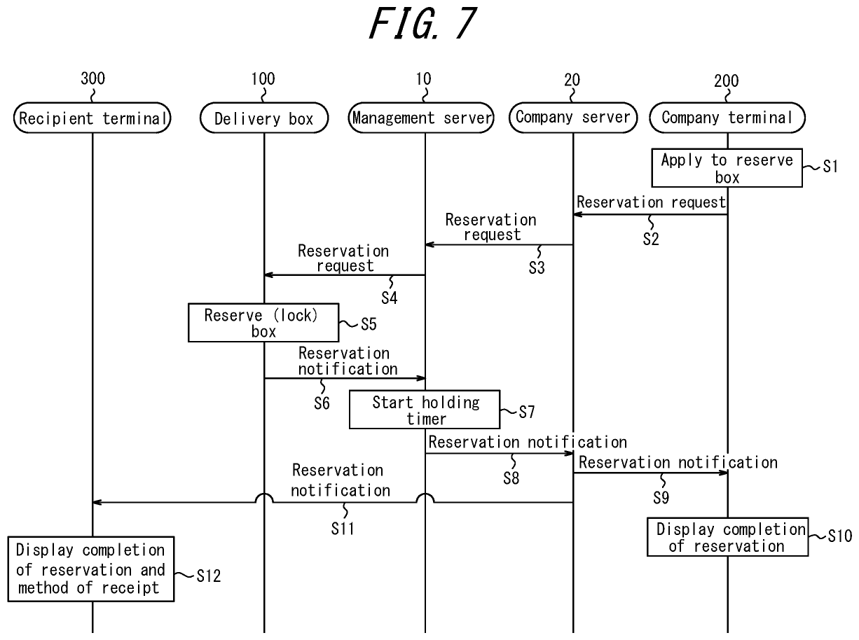

FIG. 7 illustrates an example of operations to notify the recipient terminal 300 of completion of the reservation. The operations are based on a request, made using the company terminal 200, to reserve the delivery box 100. FIG. 7 illustrates a sequence of operations of each element included in the system 1 in chronological order from the top. As illustrated in FIG. 7, the elements included in the system 1 may be the recipient terminal 300, the delivery box 100, the management server 10, the company server 20, and the company terminal 200.

The operations illustrated in FIG. 7 may start when a staff member, of the home delivery company or the like, who uses the company terminal 200 attempts to reserve the delivery box 100 installed in the residence or the like of the recipient of the package to be delivered. In other words, at this stage before delivery of the package to the recipient, such as the stage at which a delivery plan is being formulated, the staff member of the home delivery company or the like can use the company terminal 200 to remotely reserve the delivery box 100 installed in the residence or the like of the recipient of a particular package. Such use of the company terminal 200 to reserve the delivery box 100 can avoid a situation in which a package delivered by a staff member of another home delivery company is stored in the reserved delivery box.

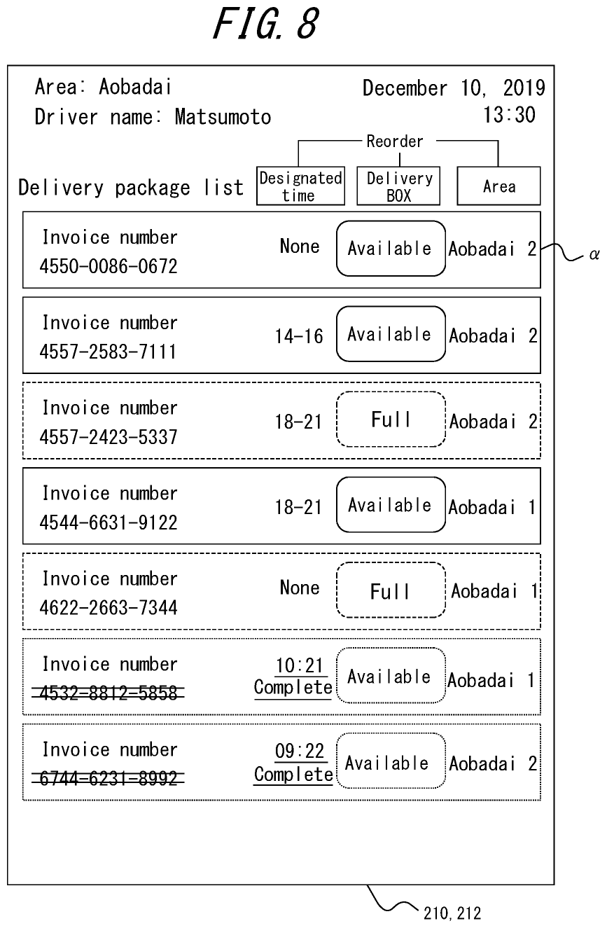

At the start of the operations in FIG. 7, the company terminal 200 may display a screen such as the one in FIG. 8 on the display 212. FIG. 8 illustrates an example of the content displayed on the display 212 of the company terminal 200 according to an embodiment. As illustrated in FIG. 8, the company terminal 200 may display various information related to package delivery on the display 212. For example, the company terminal 200 may display the current date and time along with the delivery area of the staff member using the company terminal 200, the driver name, and the like, as illustrated at the upper portion of the display 212 in FIG. 8.

The company terminal 200 may display a list of delivery packages, as illustrated on the display 212 of FIG. 8. In the example illustrated in FIG. 8, the company terminal 200 lists information related to seven delivery packages on the display 212. The company terminal 200 may display various information for each delivery package in the delivery package list on the display 212, such as an invoice number; an indication of whether a delivery time is designated, and if so, the designated time; the status of the delivery box; the delivery area; and the like.

To achieve a display like FIG. 8, the management server 10 may acquire information of the delivery box 100 in each area, such as the availability and/or reservation status. The management server 10 may periodically or irregularly acquire information such as the availability and/or reservation status of the delivery box 100 in each area to manage the delivery box 100 in each area. The company terminal 200 may issue an appropriate request, to the company server 20 or the management server 10, for information such as the availability and/or reservation status of the delivery box 100 in a predetermined area. The company terminal 200 can thus acquire the latest information on the availability and/or reservation status of the delivery box 100 in a predetermined area. The company terminal 200 may acquire various information from the management server 10 directly or acquire information from the management server 10 via the company server 20.

In the example illustrated in FIG. 8, the two packages displayed at the bottom of the display 212 may already have been delivered. In other words, the packages other than the two packages displayed at the bottom of the display 212 may be packages to be subsequently delivered.

In the example in FIG. 8, the delivery box 100 item is displayed as “full” for the third and the fifth packages from the top of the delivery package list. This may indicate that the delivery box 100 installed in the residence or the like of the recipient of the package is unavailable. Accordingly, the staff member of the home delivery company cannot store such a package in the delivery box 100 at the time of delivery if the package cannot be hand delivered due, for example, to the recipient not being home. In such a case, the staff member of the home delivery company is forced to redeliver the delivered package.

In the example in FIG. 8, the delivery box 100 item is displayed as “available” for the first, second, and fourth packages from the top of the delivery package list. This may indicate that the delivery box 100 installed in the residence or the like of the recipient of the package is available. Accordingly, the staff member of the home delivery company can store such a package in the delivery box 100 at the time of delivery even if the package cannot be hand delivered due, for example, to the recipient not being home. The staff member of the home delivery company does not need to redeliver the delivered package if the package can be stored in the delivery box 100.

The availability and/or reservation status of the delivery box 100 may change constantly, however. The company terminal 200 may update the display on the display 212 by issuing an inquiry to the management server 10 or the company server 20 for the latest information regarding the availability and/or reservation status of the delivery box 100 in a predetermined area. Even if the delivery box 100 item on the display 212 is “available” when the staff member of the home delivery company confirms the display, the delivery box 100 item may change to “full” by the time the staff member arrives at the location of the delivery box 100. In this case, the staff member of the home delivery company is still forced to redeliver the delivered package at the time of delivery if the package cannot be hand delivered due, for example, to the recipient not being home.

The system 1 according to an embodiment may address this issue by enabling the staff member of the home delivery company to use the company terminal 200 to reserve the delivery box 100 installed in the residence or the like of the recipient of the package to be delivered. As described above, the display 212 of the company terminal 200 may be configured together with the operation interface 210 as a touchscreen display, for example. In this case, the company terminal 200 may detect input on the operation interface 210 by detecting a touch by the staff member of the home delivery company on a package item displayed on the display 212. For example, suppose that a touch is detected in the operation interface 210 on the column in which item α is displayed in FIG. 8, or on the icon “available” in this column. The company terminal 200 in this case transmits a reservation request for the delivery box 100 installed in the residence or the like of the recipient of the package (invoice number 4550-0086-0672) to the company server 20.

In this way, based on a predetermined operation by a staff member of the home delivery company, the company terminal 200 may judge that a reservation application for a particular delivery box 100 has been made (step S1 in FIG. 7). When it is judged that a reservation application has been made for a particular delivery box 100, the company terminal 200 transmits a reservation request based on the reservation application to the company server 20 (step S2). Upon receiving the reservation request for the particular delivery box 100, the company server 20 transmits the reservation request to the management server 10 (step S3). In this way, the controller 22 of the company server 20 may perform control to transmit the request to reserve the delivery box 100 to the management server 10 via the communication interface 26 based on the request, from the company terminal 200, received by the communication interface 26. When possible, the company terminal 200 may directly transmit the reservation request for the delivery box 100 to the management server 10 without going through the company server 20.

Upon receiving the reservation request for a particular delivery box 100, the management server 10 transmits the reservation request to the particular delivery box 100 (step S4). In this way, the controller 12 of the management server 10 may perform control to transmit the request to reserve the delivery box 100 to the delivery box 100 based on the request, from the company server 20 or the company terminal 200, received by the communication interface 16.

Upon receiving the reservation request, the particular delivery box 100 reserves the container 120 that will store the package to be delivered (step S5). In step S5, the delivery box 100 may, for example, engage the electronic lock 124 of the door 122 to the container 120 requested to be reserved, so that the door 122 will not open. The controller 12 of the management server 10 may therefore perform control to transmit information requesting locking (electronic lock 124) of the storage entrance (door 122) of the delivery box 100 as the information requesting reservation of the delivery box 100.

After the delivery box 100 is reserved and locked, the delivery box 100 transmits a notification that the delivery box 100 was reserved to the management server 10 (step S6). Upon receiving the notification that the delivery box 100 was reserved, the management server 10 begins a timer that counts a predetermined length of time to hold the reservation of the delivery box 100 (step S7).

The predetermined length of time to hold the reservation of the delivery box 100 in step S7 may be such that the reservation of the delivery box 100 is held before the predetermined length of time elapses but is canceled once the predetermined length of time elapses. Cancellation of the reservation of the delivery box 100 is further described below. The predetermined length of time in step S7 may, for example, be determined based on length of time necessary for the staff member of the home delivery company to safely deliver the package to the reserved delivery box 100. The predetermined length of time may, for example, be a length of time determined by the management company of the delivery box 100, the home delivery company, or the like. The predetermined length of time may, for example, be a fixed length of time such as 30 minutes or a length of time that varies in accordance with the distance from the current location to the delivery box 100 to which the package is to be delivered.

After the timer that counts the predetermined time to hold the reservation of the delivery box 100 begins, the management server 10 transmits a notification that the delivery box 100 was reserved to the company server 20 (step S8). Upon receiving the notification that the delivery box 100 was reserved, the company server 20 transmits a notification that the delivery box 100 was reserved to the company terminal 200 (step S9). When possible, the management server 10 may directly transmit the notification that the delivery box 100 was reserved to the company terminal 200 without going through the company server 20.

Upon receiving notification that the delivery box 100 was reserved, the company terminal 200 displays an indication that the delivery box 100 was reserved on the display 212 based on the reservation application for the delivery box 100 in step S1 (step S10).

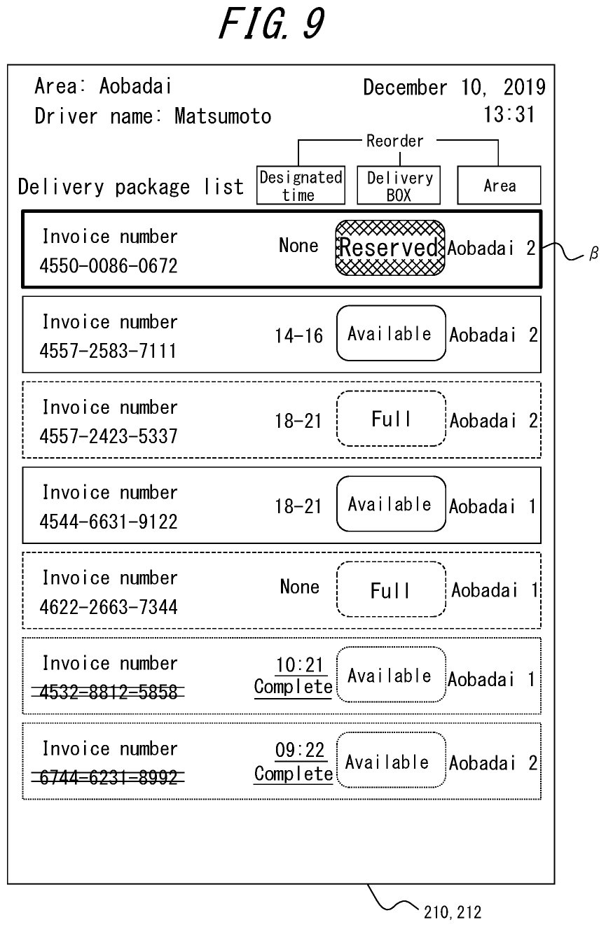

In step S10, the company terminal 200 may display a screen such as the one in FIG. 9 on the display 212. FIG. 9 illustrates an example of the content displayed on the display 212 of the company terminal 200 according to an embodiment. For example, in step S10, the company terminal 200 may change the icon “available” in the column where item α is displayed in FIG. 8 to the icon “reserved” as in the column where item β is displayed in FIG. 9 and display the result on the display 212. The staff member of the home delivery company can view the display on the display 212 of the company terminal 200 to confirm the reservation of the delivery box 100 installed in the residence or the like of the recipient of the package that the staff member is going to deliver.

Upon receiving the notification in step S8 that the delivery box 100 was reserved, the company server 20 may transmit a notification that the delivery box 100 was reserved to the recipient terminal 300 (step S11). The company server 20 may identify the recipient terminal 300 of the recipient of the package for which the delivery box 100 was reserved and transmit a notification that the delivery box 100 was reserved to the recipient terminal 300 in step S11. In this way, the controller 22 of the company server 20 may perform control to transmit a notification that the delivery box 100 was reserved to the recipient terminal 300 based on the notification, received by the communication interface 26 from the management server 10, that the delivery box 100 was reserved.

Upon receiving the notification that the delivery box 100 was reserved, the recipient terminal 300 may display a notification that the delivery box 100 was reserved on the display 312 (step S12).

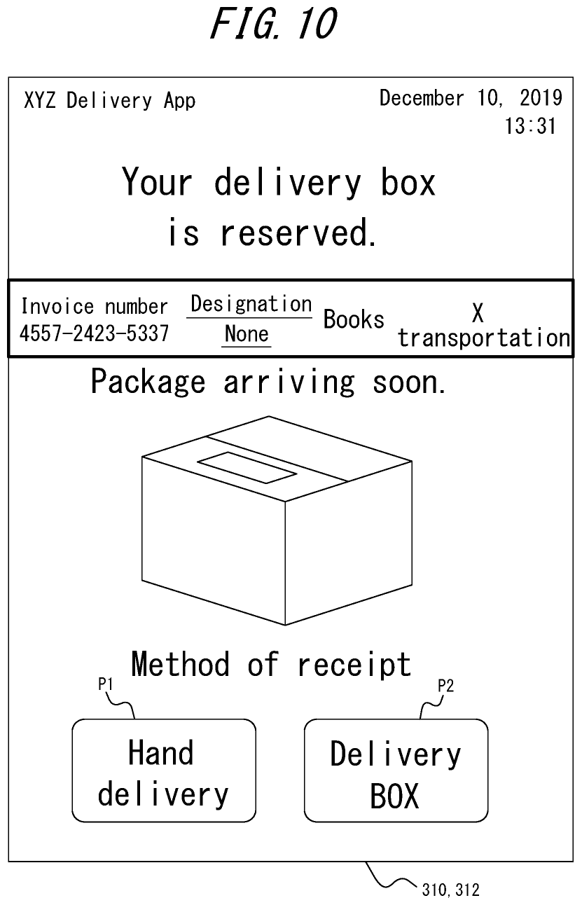

In step S12, the recipient terminal 300 may display a screen such as the one in FIG. 10 on the display 312. FIG. 10 illustrates an example of the content displayed on the display 312 of the recipient terminal 300 according to an embodiment. The recipient terminal 300 may, in step S12, display a notification on the display 312 that the delivery box 100 (installed in the residence or the like) of the recipient was reserved, as illustrated in FIG. 10, for example. The recipient of the package can view this display to learn that a package for the recipient is expected to be delivered soon by a delivery company or the like.

The recipient terminal 300 may display various information, such as the invoice number of the package to be delivered; an indication of whether a delivery time is designated, and if so, the designated time; the content of the package; the name of the company delivering the package; and the like on the display 312 in step S12, as illustrated in FIG. 10, for example. The recipient of the package can view this display to gain an overview of the package to be delivered to the recipient. The recipient of the package can also use this display to check whether the company delivering the package is a legitimate company.

When displaying an indication that the delivery box 100 was reserved, the recipient terminal 300 may display information, on the display 312, related to the predetermined length of time counted by the timer started in step S7. For example, suppose that in step S7, the management server 10 started to count 30 minutes as the predetermined length of time to hold the reservation of the delivery box 100. In this case, the recipient terminal 300 may display, on the display 312, a display such as “package will arrive within approximately 30 minutes”.

The recipient terminal 300 may be configured to display, in step S12, an indication that the delivery box 100 was reserved on the display 312 only when a dedicated application designed for use in the system 1 is running, for example. The recipient terminal 300 may instead be configured to display, in step S12, a notification that the delivery box 100 was reserved on the display 312 regardless of whether an application is running on the recipient terminal 300, for example. In step S12, the recipient terminal 300 may display some sort of notification on the display 312, and when the operation interface 310 detects that the notification is touched, the recipient terminal 300 may display a screen such as the one in FIG. 10 on the display 312.

Furthermore, the recipient terminal 300 may display a screen on the display 312, in step S12, to ask the recipient to select a method of receiving the package to be delivered. The recipient terminal 300 may display a “hand delivery” button P1 and a “delivery box” button P2 on the display 312 in step S12 as the methods of receiving the package to be delivered, as illustrated in FIG. 10, for example. When the operation interface 310 detects a touch on the “hand delivery” button P1, the recipient terminal 300 communicates the recipient's desire for hand delivery of the package to the staff member of the home delivery company. On the other hand, when the operation interface 310 detects a touch on the “delivery box” button P2, the recipient terminal 300 communicates the recipient's desire for the package to be stored in the delivery box 100 to the staff member of the home delivery company. In this way, the controller 22 of the company server 20 may perform control to transmit a notification that the delivery box 100 was reserved and an inquiry related to the method of receiving the package to the recipient terminal 300. Such selection of the method of receiving the package is further described below.

### Cancellation of Reservation of Delivery Box 100

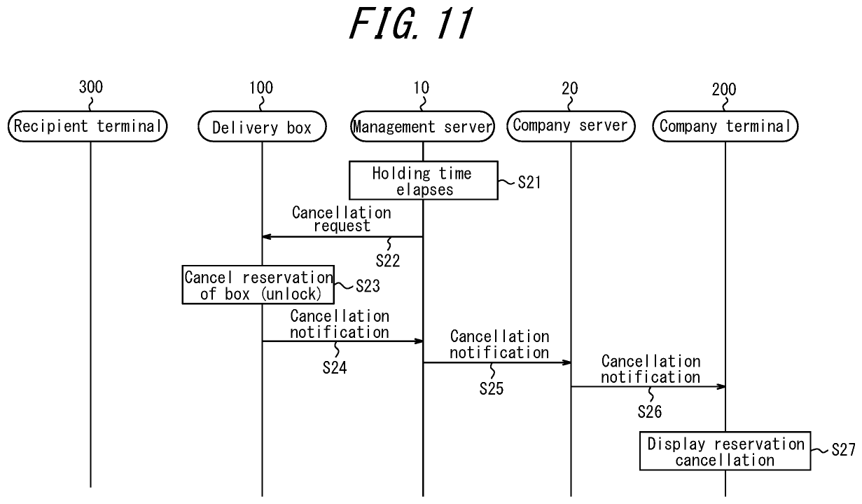

FIG. 11 illustrates an example of operations in the system 1, performed after the delivery box 100 is reserved by use of the company terminal 200, to cancel the reservation once a predetermined length of time passes. The operations of the management server 10 illustrated in FIG. 11 may follow the operations of the management server 10 illustrated in step S7 of FIG. 7. The operations of step S21 in FIG. 11 may begin after a predetermined length of time elapses from when the management server 10 starts counting with the timer in step S7 of FIG. 7. In other words, the management server 10 may start the counter of the timer in step S7 of FIG. 7 and subsequently judge that the predetermined length of time (the length of time that the reservation of the delivery box 100 is held) has elapsed in step S21 of FIG. 11.

After the length of time that the reservation of the delivery box 100 is held (the predetermined length of time) elapses, the management server 10 transmits a request to cancel the reservation to the delivery box 100 (step S22). In this way, the controller 12 of the management server 10 may perform control to transmit the request to cancel the reservation of the delivery box 100 to the delivery box 100 after the predetermined length of time elapses.

Upon receiving the request to cancel the reservation, the delivery box 100 cancels the reservation of the reserved container 120 (step S23). In step S23, the delivery box 100 may, for example, release the electronic lock 124 of the door 122 to the container 120 pertaining to the request to cancel the reservation, so that the door 122 can open. The controller 12 of the management server 10 may therefore perform control to transmit information requesting release (release of the electronic lock 124) of the storage entrance (door 122) of the delivery box 100 as the information requesting to cancel the reservation of the delivery box 100.

After the reservation of the delivery box 100 is canceled, the delivery box 100 transmits a notification that reservation of the delivery box 100 was canceled to the management server 10 (step S24). Upon receiving the notification that the reservation of the delivery box 100 was canceled, the management server 10 transmits a notification that reservation of the delivery box 100 was canceled to the company server 20 (step S25). Upon receiving the notification that the reservation of the delivery box 100 was canceled, the company server 20 transmits a notification that the reservation was canceled to the company terminal 200 (step S26). When possible, the management server 10 may directly transmit the notification that reservation of the delivery box 100 was canceled to the company terminal 200 without going through the company server 20.

Upon receiving the notification that the reservation of the delivery box 100 was canceled, the company terminal 200 displays an indication that the reservation was canceled on the display 212 (step S27). For example, in step S27, the company terminal 200 may change the icon “reserved” in the column where item β is displayed in FIG. 9 to the icon “available” as in the column where item α is displayed in FIG. 8 and display the result on the display 212. In step S27, the company terminal 200 may, for example, also change the icon “reserved” in the column where item β is displayed in FIG. 9 to an icon specifying that the reservation was canceled and display the result on the display 212. The staff member of the home delivery company can view the display on the display 212 of the company terminal 200 to confirm that the reservation of the delivery box 100 has been canceled. In this case, the delivery box 100 for which the reservation was canceled can, for example, store a package delivered by a staff member of another home delivery company or the like. The staff member of the home delivery company or the like is therefore motivated to deliver the package before the reservation is canceled. Furthermore, this configuration can reduce the frequency with which the delivery box 100 remains reserved for an extended period of time, preventing other packages from being stored.

### Selection, on Recipient Terminal 300, of Method of Receiving Package

As described in step S12 of FIG. 7, the recipient terminal 300 communicates, to the staff member of the home delivery company, the recipient's selection of the method of receiving the package to be delivered. Such selection, by the recipient, of the method of receiving a package is further described below.

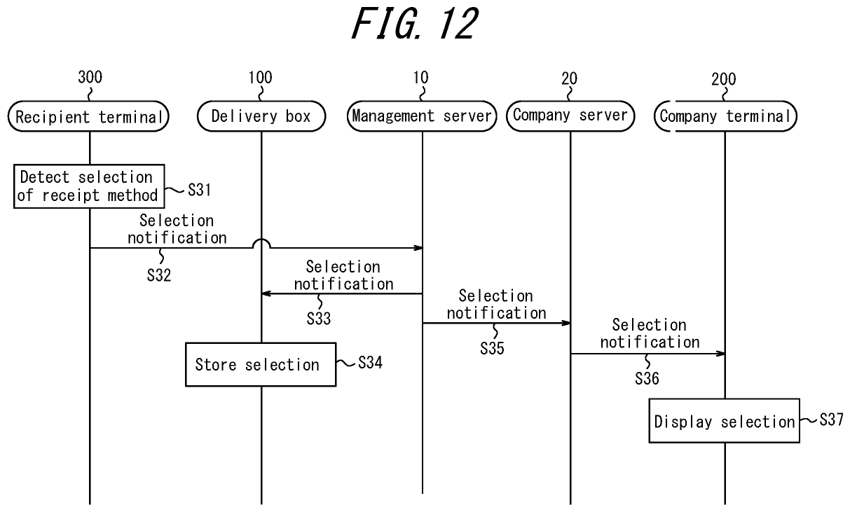

FIG. 12 illustrates an example of operations in the systems 1 to transmit, to delivery box 100 and the company terminal 200, the method of receiving the package as selected by the recipient of the package using the recipient terminal 300. The operations of the recipient terminal 300 illustrated in FIG. 12 may follow the operations of the recipient terminal 300 illustrated in step S12 of FIG. 7.

As described above, the recipient terminal 300 may display the “hand delivery” button P1 and the “delivery box” button P2 on the display 312 in step S12 as the methods of receiving the package to be delivered, as illustrated in FIG. 10, when performing the operations illustrated in step S12 of FIG. 7. If the operation interface 310 detects a touch on the “hand delivery” button P1 or the “delivery box” button P2 in this state, the recipient terminal 300 detects selection of “hand delivery” or “delivery box” by the recipient (step S31 in FIG. 12). Upon detecting selection of “hand delivery” or “delivery box”, the recipient terminal 300 transmits notification of the selection to the management server 10 (step S32). The notification of the selection in step S32 may be a notification indicating whether “hand delivery” or “delivery box” was detected as the method of receiving the package to be delivered.

In this way, after transmitting the request to reserve the delivery box 100 (step S4), the controller 12 of the management server 10 may perform control to receive a notification, from the recipient terminal 300, related to the method of receiving a package. The controller 12 may also perform control to receive the notification related to the method of receiving a package (step S32) after transmitting the request to reserve the delivery box 100 (step S4) and receiving notification that the delivery box 100 was reserved (step S6).

Upon receiving notification of selection, the management server 10 transmits notification of the selection to the delivery box 100 (step S33). In this way, the controller 12 of the management server 10 may perform control to transmit a notification related to the method of receiving the package to the delivery box 100 based on the notification, received from the recipient terminal 300, related to the method of receiving the package. Upon receiving notification of the selection, the delivery box 100 stores the selection (step S34). In other words, upon receiving notification that “hand delivery” was selected, the delivery box 100 stores an indication that the recipient desires “hand delivery” of the package. Upon receiving notification that “delivery box” was selected, the delivery box 100 stores an indication that the recipient desires the package to be stored in the delivery box 100.

Upon receiving notification of selection, the management server 10 transmits notification of the selection to the company server 20 (step S35). Upon receiving notification of the selection, the company server 20 transmits notification of the selection to the company terminal 200 (step S36). When possible, the management server 10 may directly transmit a notification of the selection to the company terminal 200 without going through the company server 20. In this way, the controller 12 of the management server 10 may perform control to transmit a notification related to the method of receiving the package to the company server 20 or the company terminal 200 based on the notification, received from the recipient terminal 300, related to the method of receiving the package. Upon receiving notification of the selection, the company terminal 200 may display information based on the selection on the display 212 (step S37).

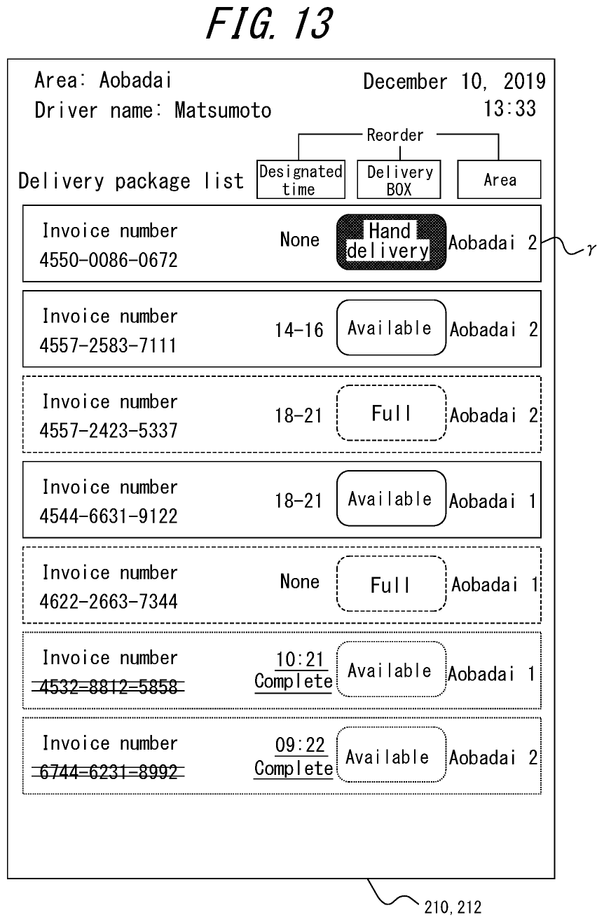

For example, in step S37, the company terminal 200 may change the icon “reserved” in the column where item β is displayed in FIG. 9 to the icon “hand delivery” as in the column where item γ is displayed in FIG. 13 and display the result on the display 212. The staff member of the home delivery company can view the display on the display 212 of the company terminal 200 to learn that the recipient of the package for which the delivery box 100 was reserved wishes for the package to be hand delivered. The staff member of the home delivery company can also infer that the recipient of the pack is likely to be home if the package is delivered to the recipient within the time that the reservation of the delivery box 100 is held. Accordingly, the staff member of the home delivery company or the like can make a plan for efficiently delivering the package.

### Cancellation of Reservation of Delivery Box 100 Based on Completion of Package Delivery

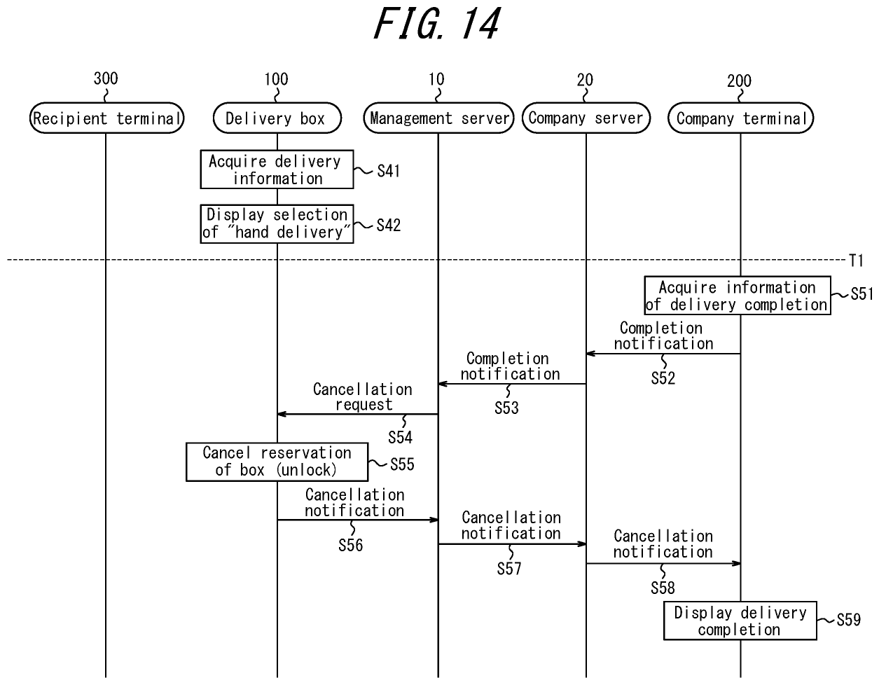

FIG. 14 illustrates an example of operations in the system 1, performed after the delivery box 100 is reserved by use of the company terminal 200, to cancel the reservation based on completion of delivery upon the package being hand delivered to the recipient. After the delivery box 100 is reserved by use of the company terminal 200, delivery of the package is complete when the package is hand delivered directly to the recipient. The delivery box 100 that was reserved for the package no longer needs to be reserved once delivery is completed by the package being hand delivered directly to the recipient. Accordingly, after the delivery box 100 is reserved for a package to be delivered in the system 1, the reservation of the delivery box 100 that was reserved for the package is canceled when the package is hand delivered to the recipient. The operations illustrated in FIG. 14 are described below, assuming that the recipient terminal 300 detected selection of “hand delivery” by the recipient in step S31 of FIG. 12.

The operations illustrated in FIG. 14 typically start at the point when the staff member, of the home delivery company or the like, who is delivering the package arrives at the location of the delivery box 100 installed in the residence or the like of the recipient of the package. For example, the operations illustrated in FIG. 14 may start after the company terminal 200 is used in step S1 of FIG. 7 to apply to reserve the delivery box 100 using the company terminal 200 (at which point the delivery box 100 has not yet been reserved). The operations illustrated in FIG. 14 may also start after step S10 of FIG. 7 in which an indication that the delivery box 100 was reserved is displayed on the company terminal 200 (at which point the delivery box 100 has already been reserved). The operations illustrated in FIG. 14 may, for example, start after the selection of the method of receipt (such as “hand delivery”) is displayed on the company terminal 200 in step S37 of FIG. 12.

At the point when the operations illustrated in FIG. 14 start, the staff member, of the home delivery company or the like, who is delivering the package is assumed to have arrived at the location of the delivery box 100 installed in the residence or the like of the recipient of the package. After the staff member, of the home delivery company or the like, who is delivering the package arrives at the location of the delivery box 100, the delivery box 100 acquires delivery information of the package (step S41). In step S41, the reader 108 of the delivery box 100 may read an identification code, such as a one-dimensional barcode or a QR code®, attached to the delivered package or a voucher of the package. The delivery box 100 may acquire delivery information of the package by reading an identification code, such as the one described above, using the reader 108. In this case, the staff member of the home delivery company or the like may hold the identification code attached to the package or a voucher of the package over (near) the reader 108 of the delivery box 100.

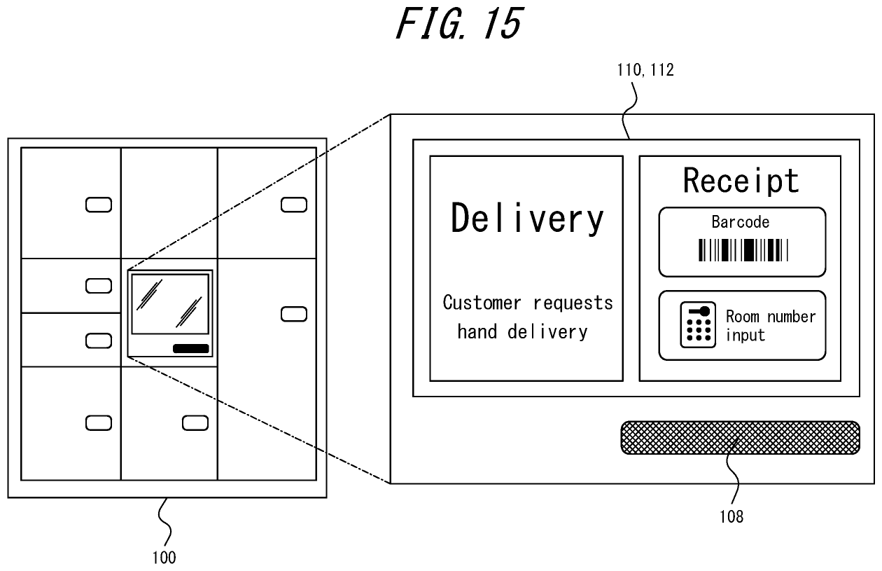

As illustrated in FIG. 15, the delivery box 100 may include the reader 108, such as a barcode reader, at a position below the display 112, for example. FIG. 15 illustrates an enlargement of a portion of the functional units of the delivery box 100, namely the reader 108, the operation interface 110, and the display 112. The delivery box 100 may acquire the delivery information of a delivered package when the staff member of the home delivery company or the like holds an identification code, such as a barcode, attached to the package over (near) the reader 108 illustrated in FIG. 15 (step S41).

In step S34, the delivery box 100 stored the selection by the recipient, in step S31 of FIG. 12, of “hand delivery” as the method of reception. Accordingly, upon acquiring the delivery information of the package in step S41, the delivery box 100 can judge that the method of receiving the package is “hand delivery”. In this case, the delivery box 100 may display an indication, on the display 112, that “hand delivery” has been selected as the method of receiving the package (step S42).

In step S42, the delivery box 100 may display a message for the staff member of the home delivery company or the like on the display 112, such as “customer requests hand delivery of package”, as illustrated in FIG. 15, for example. The staff member, of the home delivery company or the like, that delivers the package can view this display to learn that the recipient of the package desires that the package be hand delivered.

The company terminal 200 used by the staff member of the home delivery company or the like has already displayed an indication on the display 212, in step S37 of FIG. 12, indicating that the recipient of the package desires the package to be hand delivered. The staff member of the home delivery company or the like might, however, have overlooked such a display on the company terminal 200. The staff member of the home delivery company or the like might also have forgotten after viewing the display on the company terminal 200. Furthermore, the method by which the recipient desires to receive the package may have been changed after being selected once by the recipient. In these cases as well, the staff member of the home delivery company or the like can learn the method by which the recipient desires to receive the package when the staff member arrives at the delivery box 100 installed in the residence or the like of the recipient of the package.

After step S42, the staff member of the home delivery company or the like can head to the entrance of the residence of the recipient to hand deliver the package to the recipient who desires hand delivery of the package. The timing at which step S42 is complete is labeled time T1, as illustrated in FIG. 14. The time T1 is indicated by a dashed line in FIG. 14. After time T1 in FIG. 14, the staff member of the home delivery company or the like may head to the entrance of the residence of the recipient and hand deliver the package to the recipient.

After the staff member of the home delivery company or the like delivers the package to the recipient of the package, the company terminal 200 may acquire information indicating completion of delivery of the package (step S51 in FIG. 14). In step S51, the company terminal 200 may acquire information such as the invoice number listed on the delivered package (or a voucher or the like of the package). The company terminal 200 may use the reader 208 in step S51 to read a barcode or the like displayed on a voucher torn from the package when the staff member of the home delivery company or the like hand delivered the package to the recipient. As the information indicating that delivery of the package is complete, the company terminal 200 may acquire the delivery information of the package hand delivered to the recipient.

Upon acquiring the information indicating that delivery of the package is complete, the company terminal 200 transmits a notification indicating completion of delivery to the company server 20 (step S52). Upon receiving the notification indicating completion of delivery, the company server 20 transmits a notification indicating completion of delivery to the management server 10 (step S53). Upon receiving the notification indicating completion of delivery, the management server 10 transmits a request to cancel the reservation of the delivery box 100, which was reserved for the delivered package, to the delivery box 100 (step S54). In this way, before the predetermined length of time elapses, the controller 12 of the management server 10 may perform control to transmit the request to cancel the reservation of the delivery box 100 to the delivery box 100 based on the notification, from the company terminal 200, that the package was delivered to the recipient. The operations from step S55 to step S58 in FIG. 14 may be similar to the operations from step S23 to step S26 in FIG. 11.

Upon receiving the notification, in step S58, that the reservation of the delivery box 100 was canceled, the company terminal 200 displays an indication that package delivery is complete on the display 212 (step S59). For example, in step S59, the company terminal 200 may suggest that package delivery is complete as in the bottom two entries of the display 212 illustrated in FIG. 8. In step S59, the company terminal 200 may also display an indication that reservation of the delivery box 100 was canceled along with the indication that package delivery is complete on the display 212. The staff member of the home delivery company can view the display on the display 212 of the company terminal 200 to confirm that delivery of the package is complete.

As described above, in step S41 of FIG. 14, the staff member of the home delivery company or the like arrives at the delivery box 100 installed in the residence or the like of the recipient of the package, and the delivery box 100 can acquire delivery information of the package. In step S42, the delivery box 100 then displays an indication that “hand delivery” has been selected by the recipient as the method of receiving the package. The staff member of the home delivery company or the like can view this display and head to the entrance of the residence of the recipient in order to hand deliver the package.

However, the recipient may have had to leave, for example to attend to an urgent matter. In such a case, it is envisioned that the package cannot be hand delivered to the recipient despite the recipient having selected “hand delivery” as the method of receiving the delivered package. If the package is delivered within the length of time for which the reservation of the delivery box 100 is held in the system 1, the staff member of the home delivery company or the like can in this case store the package in the delivery box 100 when the package cannot be hand delivered to the recipient. The operations in this case are described below.

### Storage in Delivery Box 100 of Package Not Deliverable by Hand

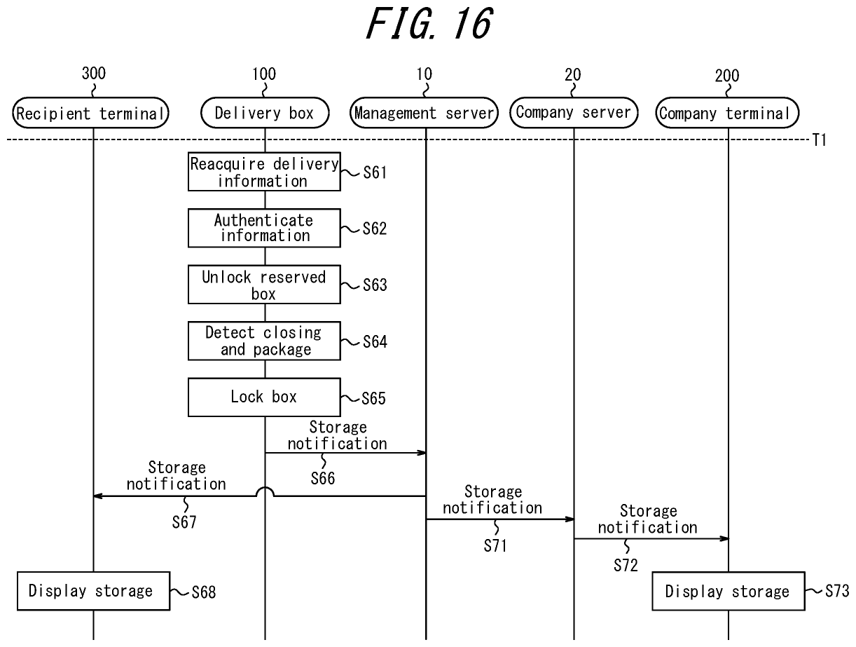

FIG. 16 illustrates an example of operations in system 1 for storage in the reserved delivery box 100 when a package cannot be hand delivered, despite hand delivery having been selected as the method of receiving the delivered package. The operations illustrated in FIG. 16 may be assumed to start after time T1 in FIG. 14. As in FIG. 14, the time T1 is indicated by a dashed line in FIG. 16. In other words, at the point when the operations illustrated in FIG. 16 start, the delivery box 100 may have acquired delivery information of the package (step S41 of FIG. 14) and may have displayed an indication that “hand delivery” was selected as the method of receipt (step S42).

When the operations illustrated in FIG. 16 start, the staff member of the home delivery company or the like may head to the entrance of the residence of the recipient and attempt to hand deliver the package to the recipient after time T1. It is assumed that despite heading to the entrance of the residence of the recipient of the package after time T1 in FIG. 16, however, the staff member of the home delivery company or the like was unable to hand deliver the package to the recipient. It is also assumed that to store the package that could not be hand delivered in the delivery box 100, the staff member of the home delivery company or the like returns to the location of the delivery box 100.

After the staff member of the home delivery company or the like returns with the package that could not be hand delivered to the recipient, the delivery box 100 again acquires the delivery information of the package (step S61). The delivery box 100 may again acquire the same information in step S61 as the delivery information of the package previously acquired in step S41 of FIG. 14. Accordingly, in step S61, the delivery box 100 may again acquire delivery information of the package in the same way as the operation in step S41 of FIG. 14. For example, the delivery box 100 may again acquire the delivery information of the package that could not be hand delivered when the staff member of the home delivery company or the like holds an identification code, such as a barcode, attached to the package over (near) the reader 108 illustrated in FIG. 15.

Once the delivery information of the package is acquired again, the delivery box 100 authenticates the acquired delivery information of the package (step S62). In step S62, the delivery box 100 may identify the package using the required delivery information of the package and check whether the delivery box 100 has been reserved for the package. When the delivery box 100 has been reserved for the package, the delivery box 100 may judge whether the holding time of the reservation (S21 of FIG. 11) has elapsed in step S62. In other words, the delivery box 100 may authenticate the delivery information in step S62 by judging whether the delivery box 100 has been reserved for the package and/or whether the reservation is still valid.

FIG. 16 illustrates an example of the delivery box 100 authenticating the delivery information in step S62 by receiving the delivery information of the package in advance. For example, the delivery box 100 may acquire delivery information of the package in advance in step S4 of FIG. 7, step S33 of FIG. 12, step S41 of FIG. 14, or the like. The delivery box 100 may transmit the delivery information of the package to the management server 10 in step S62, and the management server 10 may authenticate the delivery information. In this case, the delivery box 100 may receive the result of authentication by the management server 10.

After the delivery information is authenticated, the delivery box 100 may release the electronic lock 124 of the door 122 to the container 120 that was reserved for the package in the delivery box 100 (step S63). In other words, when the delivery box 100 has been reserved for the package and the reservation is valid (the holding time has not elapsed) in step S62, the delivery box 100 may release the electronic lock 124 of the door 122 to the container 120 in step S63. On the other hand, when the delivery box 100 has not been reserved for the package in step S62, the delivery box 100 does not release the electronic lock 124 of the door 122 to the container 120 in step S63. If the delivery box 100 was reserved for the package, but the holding time of the reservation has elapsed in step S62, the delivery box 100 also does not release the electronic lock 124 of the door 122 to the container 120 in step S63.

After the electronic lock 124 is released in step S63, the staff member of the home delivery company or the like can store the package that could not be hand delivered to the recipient in the container 120 of the delivery box 100. After the package is stored in the delivery box 100, the delivery box 100 detects closure of the door 122 to the container 120 in which the package was stored and/or detects the package stored in the container 120 (step S64). The opening/closing detector 130 of the delivery box 100 may detect that the door 122 to the container 120 is closed in step S64. The weight detector 132 of the delivery box 100 may detect that the package is stored in the container 120 by detecting the weight of the package stored in the container 120 in step S64.

After the package and/or the closure of the door 122 is detected, the delivery box 100 engages the electronic lock 124 of the door 122 to the container 120 in which the package is stored (step S65). After the delivery box 100 is locked, the delivery box 100 transmits a notification that the package was stored to the management server 10 (step S66).

Upon receiving the notification that the package was stored, the management server 10 transmits a notification that the package was stored to the recipient terminal 300 (step S67). Upon receiving the notification that the package was stored, the recipient terminal 300 may display a notification, on the display 312, that the delivered package was stored in the delivery box 100 (step S68). The package recipient, who had selected hand delivery, can view the display on the display 312 of the recipient terminal 300 to learn that the package was stored in the delivery box 100 without being hand delivered. Accordingly, the recipient of the package can retrieve the package stored in the delivery box 100 at his or her convenience.

In this way, after transmitting the notification related to the method of receiving the package (selection of hand delivery) to the delivery box 100, the controller 12 of the management server 10 may receive a notification that the package is stored in the delivery box 100 from the delivery box 100. After receiving the notification that the package was stored in the delivery box 100, the controller 12 may perform control to transmit a notification that the package was stored in the delivery box 100 to the recipient terminal 300.

The recipient terminal 300 may also receive information in step S67, from the management server 10, for displaying an identification code to release the electronic lock 124 of the door 122 to the container 120 in the delivery box 100 where the package is stored. In this case, the recipient terminal 300 can display the identification code for unlocking the delivery box 100 along with the notification that the package was stored in the delivery box 100 on the display 312 in step S68. Accordingly, the recipient of the package can release the electronic lock 124 of the door 122 to the container 120 where the package is stored by holding the identification code over (near) the reader 108 illustrated in FIG. 15.

After receiving the notification that the package was stored, the management server 10 may also transmit a notification that the package was stored to the company server 20 (step S71). After receiving the notification that the package was stored, the company server 20 may transmit a notification that the package was stored to the company terminal 200 (step S72). When possible, the management server 10 may directly transmit a notification that the package was stored to the company terminal 200 without going through the company server 20. Upon receiving the notification that the package was stored, the company terminal 200 may display a notification, on the display 212, that the delivered package was stored in the delivery box 100 (step S73). The staff member of the home delivery company or the like can view the display on the display 212 of the company terminal 200 to recognize that the package that could not be hand delivered was stored in the delivery box 100.

As described above, the staff member of the home delivery company or the like can reserve the delivery box 100 for storing a delivered package in the system 1. Accordingly, the staff member of the home delivery company or the like can store the delivered package in the reserved delivery box 100 when the recipient is not home at the time of delivery. The system 1 can therefore avoid the need for the staff member of the home delivery company or the like to redeliver the package. The length of time for which the delivery box 100 is reserved, however, is limited in the system 1. The reservation is canceled after a predetermined length of time elapses. The staff member of the home delivery company or the like is therefore motivated to deliver the package before the reservation is canceled. Furthermore, this configuration can reduce the frequency with which the delivery box 100 remains reserved for an extended period of time, preventing other packages from being stored.

An indication that the delivery box 100 was reserved for the package is displayed on the recipient terminal 300 in the system 1. The recipient of the package can thereby learn that the package will be delivered soon. Furthermore, the system 1 enables the recipient of the package to be delivered to choose whether to receive the package by hand or to have the package stored in the delivery box 100. The system 1 also enables the package to be stored in the reserved delivery box 100 when the package cannot be delivered by hand, despite the recipient having selected hand delivery. The system 1 can therefore avoid the need for the staff member of the home delivery company or the like to redeliver the package.

The system 1 according to an embodiment is therefore capable of streamlining package delivery in the context of a service to deliver packages to recipients. The system 1 according to an embodiment is also beneficial for both delivery companies and recipients of packages.

### Case of “Delivery Box” Being Selected as Method of Receiving Package

The recipient terminal 300 has been described in the above embodiment as having detected selection by the recipient of “hand delivery” in step S31 of FIG. 12. In other words, the recipient of the package has been described above as having selected “hand delivery” as the method of receiving the package to be delivered. The case of the recipient terminal 300 detecting selection of “delivery box” by the recipient in step S31 of FIG. 12 is described below. In other words, the recipient of the package is assumed to have selected storage in the delivery box 100 as the method of receiving the package to be delivered and to have touched the “delivery box” button P2 displayed on the display 312 of the recipient terminal 300 in FIG. 10.

When selection of the “delivery box” is detected in step S31 of FIG. 12, the delivery box 100 may store the selection of the “delivery box” with the operations from step S32 to step S34 of FIG. 12. The delivery box 100 has already been reserved at this point, however, for the package to be delivered (step S5 of FIG. 7). The operations in steps S33 and S34 of FIG. 12 may therefore be omitted. In other words, the delivery box 100 need not store the selection of the “delivery box”. In this case, in accordance with the operations from step S35 to step S37 of FIG. 12, the company terminal 200 may display an indication that “delivery box” was selected on the display 212.

It is assumed that the operations illustrated in FIG. 14 begin after selection of the “delivery box” is detected in step S31 of FIG. 12, and that the staff member of the home delivery company or the like has arrived at the location of the delivery box 100 installed in the residence or the like of the recipient of the package. In this case, after the delivery box 100 acquires the delivery information of the package in step S41 of FIG. 14, the package may be stored in the delivery box 100 reserved for the delivered package. After step S41 of FIG. 14, the delivery box 100 can therefore follow the operations from step S62 onward in FIG. 16 for storage of the delivered package in the delivery box 100.

Although the present disclosure is based on embodiments and drawings, it is to be noted that various changes and modifications will be apparent to those skilled in the art based on the present disclosure. Therefore, such changes and modifications are to be understood as included within the scope of the present disclosure. For example, the functions and the like included in the various functional components may be reordered in any logically consistent way. A plurality of functional components may be combined into one, or one functional component may be divided. The embodiments of the present disclosure are not limited to being implemented precisely as described and may be implemented by combining or partially omitting the features thereof as appropriate.

In the above-described embodiment, the timer that measures the holding time of delivery box 100 has been described as starting to count at the time of step S7 of FIG. 7. The time at which the holding time of the reservation starts, however, may be a different point in time, such as the point in time when the management server 10 receives the request to reserve a particular delivery box 100 in step S3 of FIG. 7. In the above-described embodiment, the start of the holding time of the reservation and the elapse of the holding time have been described as being judged by the management server 10. Each delivery box 100, however, may judge the start of the holding time of the reservation and the elapse of the holding time. The controller 102 of the delivery box 100 may include a function to measure time. Alternatively, a function to measure time may be omitted from both the management server 10 and the delivery box 100.

In the above-described embodiment, the elapse of the holding time of the reservation for the delivery box 100 is judged in step S21 of FIG. 11. In other words, the timer that measures the holding time of the delivery box 100 starts, and when the holding time of the reservation elapses, the reservation of the delivery box 100 is immediately canceled in the above-described embodiment. The reservation of the delivery box 100 is therefore canceled if the package is not stored in the delivery box 100 before the holding time of the reservation elapses. The system 1 may be configured, however, so that if the package arrives near the reserved delivery box 100 before the holding time of the reservation elapses, the reservation of the delivery box 100 is not canceled when the holding time elapses.

For example, the system 1 may be configured so that if the operation of step S41 in FIG. 14 is complete before the holding time of the reservation elapses, the reservation of the delivery box 100 is not canceled when the holding time elapses. In other words, as long as the identification code of the package is read by the reader 108 of the delivery box 100 before the holding time of the reservation elapses, the reservation of the delivery box 100 is not canceled when the holding time elapses in this case. For example, the system 1 may be configured so that if the operation of step S61 in FIG. 16 is complete before the holding time of the reservation elapses, the reservation of the delivery box 100 is not canceled when the holding time elapses. That is, as long as the identification code of the package that could not be hand delivered is read by the reader 108 of the delivery box 100 before the holding time of the reservation elapses, the reservation of the delivery box 100 is not canceled when the holding time elapses in this case.

In the above-described embodiment, the system 1 has been described as including two servers, i.e. the management server 10 and the company server 20. In this way, the system 1 may include a first server and a second server. The first server in this case communicates with the second server. The first server may be the server of the company (management server) that communicates with a storage device such as a delivery box and manages the storage device. The second server may be a server that is used by a company such as a delivery company and communicates with a terminal (company terminal) used by a staff member of the company. The first server (management server) may also be a server other than the server (company server) used by the delivery company.

On the other hand, when these servers are integrated into one server, the system 1 may be configured to include one server. The system in this case may include a delivery box 100 that stores the package delivered to the recipient, a server that communicates with at least the delivery box 100, and a company terminal 200 that communicates with at least the server. Based on a request from the company terminal 200, the server may transmit a request to reserve the delivery box 100 to the delivery box 100, and after a predetermined length of time elapses, the server may transmit a request to cancel the reservation of the delivery box 100 to the company terminal 200. Before the predetermined length of time elapses, the server may perform control to transmit the request to cancel the reservation of the delivery box 100 to the delivery box 100 based on a notification, from the company terminal 200, that the package was delivered to the recipient.

When information stored in the company server 20 is information that should not be transmitted to the management server 10 during communication between the management server 10 and the company server 20, the company server 20 may transmit information other than this information that should not be transmitted. For example, when the company server 20 is a server operated by the delivery company, and the management server 10 is a server operated by someone other than the delivery company, the company server 20 should not transmit personal information, stored on the company server 20, of the recipient of the package to the management server 10. In this case, the company server 20 may refrain from transmitting personal information of the recipient of the package to the management server 10 and transmit only information that does not identify the personal information of the recipient of the package to the management server 10 (for example, an invoice number or the identification code, such as a barcode, attached to the delivered package).

The above-described embodiment is not limited to being implemented only as the management server 10 included in the system 1. For example, the above-described embodiment may be implemented as the company server 20 included in the system 1. Furthermore, the above-described embodiment may be implemented as a system that includes one or more servers such as the management server 10 and/or the company server 20 included in the system 1. The above-described embodiment is not limited to being implemented as a server (device) such as the management server 10 and/or the company server 20 included in the system 1. For example, the above-described embodiment may be implemented as a control method of a server (device) such as the management server 10 and/or the company server 20 included in the system 1. Furthermore, the above-described embodiment may be implemented as a non-transitory computer-readable medium including a program to be executed by a server (device) such as the management server 10 and/or the company server 20 included in the system 1.

The delivery box 100 according to an embodiment is not limited to being installed in the entrance or the like of a housing complex, such as a condominium. For example, the delivery box 100 according to an embodiment may be installed in a public space, such as a railway station, or in a store, such as a convenience store.

1. A system comprising:
a server;
a terminal to be used by a delivery company;
a terminal to be used by a recipient of a package; and
a storage device comprising a container configured to store the package;
wherein when the storage device is selected, by the delivery company on the terminal to be used by the delivery company, to reserve the container, the terminal to be used by the delivery company is configured to transmit a request for reservation of the container to the server;
wherein when the storage device receives the request from the server, the storage device is configured to reserve the container and transmit a notification indicating that the container is reserved to the server;
wherein when the server receives the notification, the server is configured to transmit information indicating that the container is reserved to the terminal to be used by the recipient of the package; and
wherein when the terminal to be used by the recipient of the package receives the information indicating that the container is reserved from the server, the terminal to be used by the recipient of the package is configured to display the information indicating that the container is reserved on the terminal to be used by the recipient of the package.

2. The system of claim 1, wherein the storage device is configured to cancel the reservation of the container when the storage device receives a request to cancel the reservation from the server.

3. The system of claim 1, wherein the storage device is configured to cancel the reservation of the container when a predetermined time elapses after the container is reserved without the package being stored in the container and without the storage device receiving a request to cancel the reservation of the container from the server.

4. The system of claim 1,
wherein when the container is reserved, the terminal to be used by the recipient is configured to display information indicating that the container is reserved on the terminal to be used by the recipient of the package, to selectably display a method of receiving the package, and to transmit a storage device usage notification to the server indicating use of the storage device as the method of receiving the package when the recipient selects use of the storage device as the method of receiving the package;
wherein when the server receives the storage device usage notification, the server is configured to transmit storage device usage information, to the terminal to be used by the delivery company, indicating use of the storage device as the method of receiving the package; and
wherein when the terminal to be used by the delivery company receives the storage device usage information from the server, the terminal to be used by the delivery company is configured to change a display on the terminal to be used by the delivery company based on the storage device usage information.

5. The system of claim 4, wherein the storage device is configured to cancel the reservation of the container when hand delivery of the package is selected as the method of receiving the package and hand delivery of the package is completed.

6. A storage device comprising:
a container;
a controller; and
a communication interface configured to communicate with a server;
wherein when the controller receives a request for reservation of the container from the server, the controller is configured to reserve the container and transmit a notification indicating that the container is reserved to the server.

7. A server comprising:
a controller; and
a communication interface configured to communicate with a terminal to be used by a recipient of a package and a storage device comprising a container configured to store the package;
wherein when the controller receives a notification, via the communication interface, indicating that the container is reserved, the controller is configured to transmit information, via the communication interface, indicating that the container is reserved to the terminal to be used by the recipient of the package.
